(19) United States
(12) Patent Application Publication
(10) Pub. No.: US 2026/0233856 A1
(43) Pub. Date: Aug. 13, 2026

(54) HEIGHT ADJUSTMENT DEVICES, SYSTEMS INCLUDING THE SAME, AND METHODS FOR CREATING VERTICAL CLEARANCE BETWEEN WINGS OF ADJACENT AIRCRAFT

(71) Applicant: The Boeing Company, Arlington, VA (US)

(72) Inventors: Thomas Skyler Sartorius, San Luis Obispo, CA (US); Robert E. Grip, Rancho Palos Verdes, CA (US); Eric Daniel Davidson, Long Beach, CA (US)

(21) Appl. No.: 19/053,183

(22) Filed: Feb. 13, 2025

(51) Int. Cl. B64F 1/36

(52) U.S. Cl. CPC B64F 1/36

(57) ABSTRACT

Height adjustment devices can temporarily and selectively adjust a height of at least a first portion of a first aircraft while the first aircraft is engaged with the height adjustment device. Height adjustment devices may include a ramp configured to engage at least a first main landing gear on at least one side of the first aircraft. The ramp may include a first angled portion, a second angled portion, and a level portion positioned between the first angled portion and the second angled portion. A width of the ramp may be sufficient to receive the first main landing gear, and the height adjustment device may be configured to guide the first aircraft to transition the first aircraft from an entering position to a final position to enable large wingspan aircraft to be parked next to each other in narrower airport gates.

### FIELD

The present disclosure relates to height adjustment devices, systems including the same, and methods for creating vertical clearance between the wings of adjacent aircraft, more particularly for large span aircraft parked near each other.

### BACKGROUND

While larger wingspan aircraft may be more efficient, airport gate constraints limit the span of aircraft. For example, FIG. 1 illustrates an overhead view of adjacent gates 10 at an airport. Large span aircraft 14 are superimposed into respective gates 10, illustrating respective spacing if such aircraft 14 were to be parked next each other. Specifically, a wingspan 16 of each aircraft 14 is greater than a width 18 of each gate 10, which would result in interference between adjacent wings 20 of adjacent aircraft 14, as indicated by interference points 22. Thus, such large span aircraft may be unable to utilize these airport gates due to the sizing of their wingspans relative to the gate width.

However, various factors such as airports’ investment in their current gate spacing arrangements and/or space constraints limit the willingness and/or ability of airports to expand or increase spacing at adjacent gates to accommodate large span aircraft. Attempts have been made to overcome these spacing limitations, such as with aircraft having winglets or wing folds. However, wing folds are heavy and expensive and create new issues and challenges with respect to certification, operation, and reliability. Furthermore, folding wing tips create an increased complexity of the construction of the wing, increased manufacturing and maintenance costs, and have limited success because only a limited amount of the wing can be folded. Winglets create an increased manufacturing complexity and cost and are less desirable aerodynamically and structurally than simply increasing the span of a planar wing. None of the existing solutions, therefore, are entirely satisfactory.

### SUMMARY

The present disclosure concerns systems and designs to enable larger span aircraft to utilize existing airport gate spacing and effectively enabling closer spacing of large span aircraft in narrow airport gates. Disclosed height adjustment devices tilt and/or lift an incoming aircraft and/or an adjacent aircraft so that the wings of those aircraft have sufficient vertical clearance to allow the aircraft to pass each other without interference and park at gates spaced more closely than the wingspan.

A height adjustment device configured to temporarily and selectively adjust a height of at least a first portion of a first aircraft while the first aircraft is engaged with the height adjustment device may include a ramp configured to engage at least a first main landing gear on at least one side of the first aircraft. The ramp may include a first angled portion, a second angled portion, and a level portion positioned between the first angled portion and the second angled portion. A width of the ramp may be sufficient to receive the first main landing gear, and the height adjustment device may be configured to guide the first aircraft to transition the first aircraft from an entering position to a final position.

Disclosed kits include a plurality of height adjustment devices. In some examples, a kit may include a first height adjustment device configured to engage a first type of aircraft, and a second height adjustment device configured to engage a second type of aircraft, where the first type of aircraft is different from the second type of aircraft.

Disclosed systems for close gate spacing of large span aircraft may include a plurality of height adjustment devices each configured to temporarily and selectively adjust a height of at least a first portion of a respective aircraft while the respective aircraft is engaged with a respective height adjustment device. The plurality of height adjustment devices may be spaced apart in a plurality of different locations of an airport. Systems may further include a plurality of tugs, a control system, and at least one aircraft sensor. Each tug may be configured to position a respective aircraft on a respective height adjustment device. The control system may be configured to position one or more height adjustment devices relative to each other and relative to one or more aircraft. The aircraft sensor(s) may be positioned on or within the aircraft, and may be configured to measure and/or provide information regarding the height, orientation, and/or position of one or more points on the aircraft, and/or to measure or provide information regarding a distance between one or more points on the aircraft and an adjacent aircraft or other object.

Disclosed methods may include adjusting a height of at least a portion of a first aircraft via a height adjustment device (e.g., a ramp configured to engage at least a first main landing gear on at least one side of the first aircraft), and translating the first aircraft with respect to a second aircraft while the first aircraft is engaged with the height adjustment device, such that the first aircraft is tilted or has an adjusted height while the first aircraft is moved with respect to the second aircraft. The first aircraft may be translated with respect to the second aircraft until a first wing of the first aircraft is moved past a second wing of the second aircraft. Then, methods may include leveling the first aircraft after the translating the first aircraft with respect to the second aircraft.

### BRIEF DESCRIPTION OF THE DRAWINGS

FIG. 1 is a top plan view of a prior art airport configuration that would preclude large span aircraft parked next to each other.

FIG. 2 is a front elevation schematic representation of a first aircraft engaged with a height adjustment device according to the present disclosure.

FIG. 3 is a top plan schematic representation of a first aircraft in an entering position before entering an airport gate positioned between adjacent aircraft while the first aircraft is engaged with a height adjustment device according to the present disclosure.

FIG. 4 is a top plan schematic representation of a first aircraft being translated past an adjacent aircraft via presently disclosed height adjustment devices.

FIG. 5 is a top plan schematic representation of a first aircraft in a final position after entering an airport gate positioned between adjacent aircraft, having been transitioned past the adjacent aircraft’s wing via a height adjustment device according to the present disclosure.

FIG. 6 is a front elevation schematic representation of the first aircraft with respect to the second aircraft, in the final position shown in FIG. 5.

FIG. 7 is a schematic black box representation of systems including height adjustment devices according to the present disclosure.

FIG. 8 is a schematic representation of an aircraft that includes one or more aircraft sensors of presently disclosed systems.

FIG. 9 is a front elevation schematic representation of a first aircraft engaged with and tilted by a first height adjustment device according to the present disclosure adjacent to a second aircraft engaged with and tilted by a second height adjustment device according to the present disclosure.

FIG. 10 is a front elevation schematic representation of a first aircraft engaged with and lifted by a height adjustment device according to the present disclosure adjacent to a second aircraft positioned on the ground surface.

FIG. 11 is a front elevation schematic representation of a first side of an aircraft engaged with and lifted by a height adjustment device according to the present disclosure while a second side of the aircraft is lowered below the ground surface.

FIG. 12 is a perspective view of an example of a height adjustment device according to the present disclosure.

FIG. 13 is a perspective cutaway view of an example of a height adjustment device according to the present disclosure.

FIG. 14 is an internal perspective view of internal structures of a height adjustment device according to the present disclosure.

FIG. 15 is a side elevation view of an example of a height adjustment device according to the present disclosure.

FIG. 16 is a top plan view of an example of a height adjustment device according to the present disclosure.

FIG. 17 is a top plan view of an example of a height adjustment device according to the present disclosure.

FIG. 18 is a top plan view of an example of a height adjustment device according to the present disclosure.

FIG. 19 is a top plan view of an example of a height adjustment device according to the present disclosure.

FIG. 20 is a perspective schematic representation of an example of an interconnected height adjustment device according to the present disclosure.

FIG. 21 is a schematic flowchart diagram of methods of docking or parking an aircraft using one or more height adjustment devices according to the present disclosure.

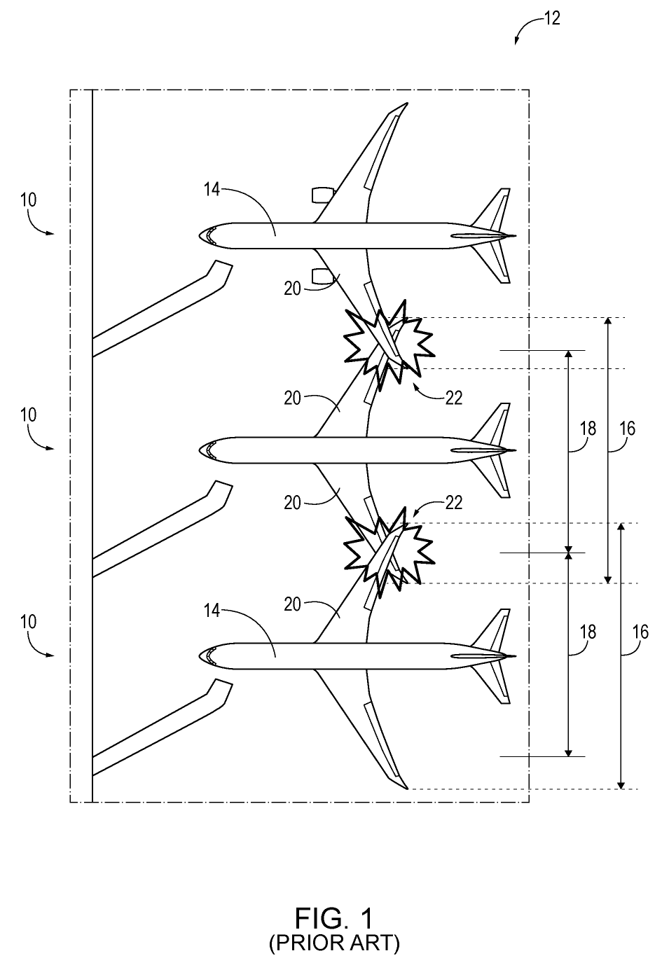

### DESCRIPTION

Generally, in the figures, elements that are likely to be included in a given example are illustrated in solid lines, while elements that are optional to a given example or that correspond to one or more specific examples are illustrated in broken lines. However, elements that are illustrated in solid lines are not essential to all examples of the present disclosure, and an element shown in solid lines may be omitted from a particular example without departing from the scope of the present disclosure.

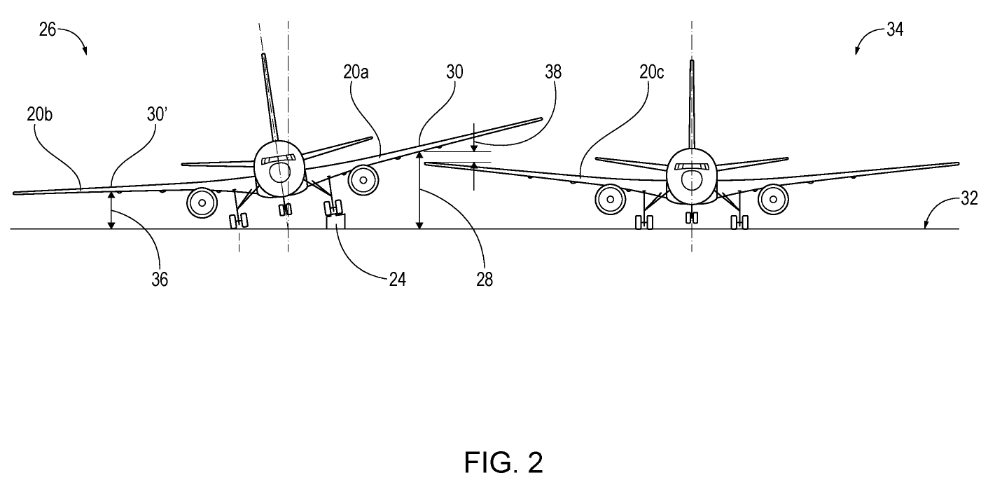

FIG. 2 schematically represents the use of height adjustment devices 24 according to the present disclosure to temporarily and selectively adjust a height of at least a portion of an aircraft (e.g., a first aircraft 26) while the aircraft is engaged with height adjustment device 24. For example, height adjustment device 24 may be configured to adjust a vertical distance 28 between a point 30 on a wing 20a of first aircraft 26 and a ground surface 32 or a floor surface on which a portion of first aircraft 26 is positioned when first aircraft 26 is engaged with height adjustment device 24. In this manner, wing 20a may be temporarily lifted and/or tilted such that first aircraft 26 may move past or be moved past a second aircraft 34 in situations where wings 20 of first aircraft 26 (e.g., wing 20a) and second aircraft 34 (e.g., wing 20c) would otherwise interfere with each other and prevent aircraft 26, 34 from moving past one another. To accomplish this, height adjustment device 24 may be configured to tilt and/or lift first aircraft 26 such that wing 20a of first aircraft 26 is vertically offset from wing 20c of second aircraft 34 (e.g., by a vertical offset 38) while first aircraft 26 is engaged with height adjustment device 24. Thus, in use, some examples of height adjustment device 24 (such as shown in FIG. 2) increase vertical distance 28 between point 30 on one wing (e.g., wing 20a) and ground surface 32, while decreasing a vertical distance 36 between a corresponding point 30’ on opposite wing 20b and ground surface 32. The location of point 30 along the length of wing 20 may vary depending on the geometry of the aircraft and the particular implementation of height adjustment device(s) 24 used. Examples of height adjustment device 24 may be configured to tilt first aircraft 26 at a tilt angle of 0 degrees, up to about 1 degree, up to about 2 degrees, up to about 3 degrees, up to about 4 degrees, up to about 5 degrees, up to about 6 degrees, up to about 7 degrees, up to about 8 degrees, up to about 9 degrees, and/or up to about 10 degrees. Larger tilt angles may be utilized in some examples, depending on the type of aircraft involved and the situational requirements. For example, the concepts of disclosed height adjustment devices 24 may be adapted to be utilized in situations involving parking short-span fighter jets on an aircraft carrier, in which higher tilt angles up to 45 degrees or more may be used. Lower tilt angles may be sufficient in some examples, such as when an incoming aircraft does not need to clear winglets of an adjacent aircraft.

The maximum tilt angle may be limited by, or influenced by, passenger comfort or tolerance in examples of height adjustment devices 24 used with passenger aircraft. Height adjustment device 24 may be configured to tilt first aircraft 26 through a range of different tilt angles in some examples. In other examples, height adjustment devices 24 may be configured to adjust the overall height of first aircraft 26 without tilting it, such that vertical distances 28, 36 of wings 20a, 20b may be substantially equal when first aircraft 26 is engaged with height adjustment device 24, while in still other examples, height adjustment device 24 may both tilt and lift first aircraft 26. For example, height adjustment device 24 may be configured to elevate the entire aircraft relative to ground surface 32 (or other floor surface supporting the aircraft), such as via one or more jacks or lifts configured to vertically lift a portion of first aircraft 26 above ground surface 32 supporting the aircraft. In this manner, height adjustment device 24 may be adjustable such that height adjustment device 24 is configured to adjust the aircraft to a plurality of different heights.

Various examples of height adjustment device 24 may be configured to lift both a right side and a left side of the aircraft while the aircraft is engaged with height adjustment device 24, vertically translate one landing gear of the aircraft while the aircraft is engaged with height adjustment device 24, and/or vertically translate both sides of the aircraft landing gear while the aircraft is engaged with height adjustment device 24. Height adjustment device 24 is generally configured to provide sufficient vertical clearance to allow the aircraft to park at an airport gate that spaced more closely to an adjacent airport gate than a wingspan of the aircraft. Height adjustment device 24 may be configured to accommodate different types of aircraft with different lengths of landing gear. Additionally or alternatively, height adjustment device 24 may be used to even out or otherwise adjust (e.g., raise) a sill height of various different types of aircraft such that ground surface equipment and crew may access the cargo area of different sizes of aircraft from a common height (e.g., as adjusted by height adjustment device 24). For example, if an airport’s ground surface equipment is designed to reach or access a first aircraft’s cargo area at a first sill height, disclosed height adjustment devices 24 may be used to raise or lower a second aircraft having a second (e.g., different) sill height, in order to make the effective sill height of the second aircraft close to or the same as the first sill height. In this manner, height adjustment devices 24 may be configured for evening out the sill heights of different types of aircraft such that the same ground surface equipment configured to access the first aircraft’s cargo area can also access the second aircraft’s cargo area when the second aircraft is engaged with height adjustment device 24, due to the adjustment in height of the second aircraft.

To engage height adjustment device 24 with the aircraft, the aircraft generally may be positioned on height adjustment device 24, such as by driving the aircraft onto height adjustment device 24, or tugging or towing the aircraft onto height adjustment device 24. In some examples, height adjustment device 24 is configured to passively engage and align the aircraft, while in some examples, height adjustment device 24 is configured to actively engage and align the aircraft. For example, height adjustment device 24 may be configured to laterally align the main landing gear of the aircraft to ensure that the aircraft is positioned correctly with respect to height adjustment device 24. In some examples, height adjustment device 24 is autonomous, such that it may be positioned and/or adjusted without requiring user input. For example, height adjustment device 24 may be configured to move around an airport or other space, sense incoming aircraft, position itself with respect to the aircraft for proper engagement with the aircraft, and pull the aircraft onto or otherwise in engagement with height adjustment device 24. Additionally or alternatively, height adjustment device 24 may include at least one motor configured to operate height adjustment device 24 such that the aircraft is passively engaged with height adjustment device 24. In some examples, height adjustment device 24 is configured to actively engage the aircraft by effectively grabbing one or more wheels of the landing gear, and pulling the aircraft into engagement with height adjustment device 24 without requiring the use of aircraft power.

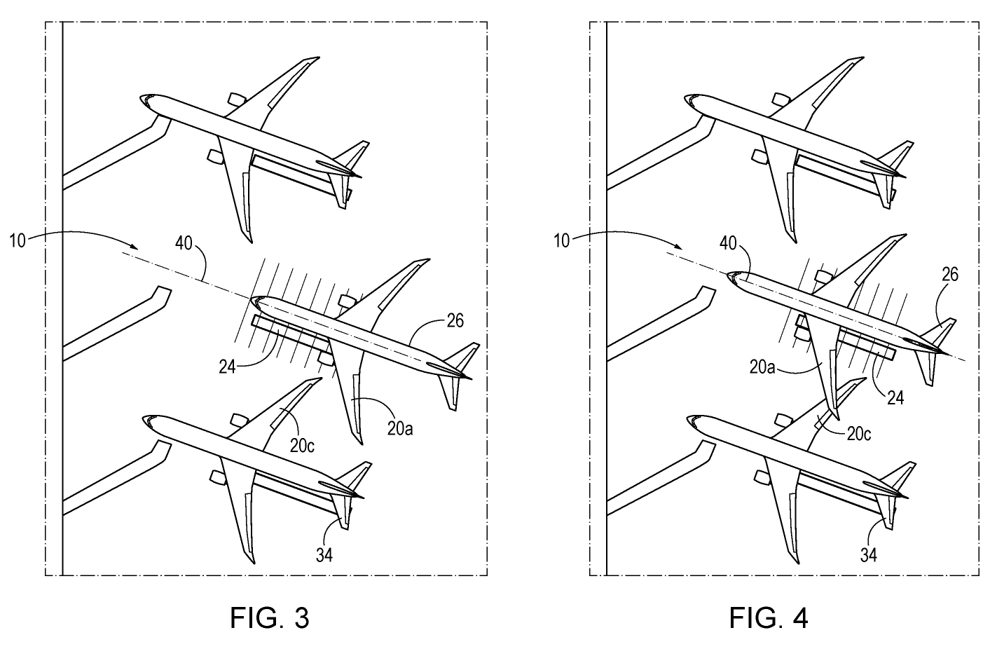

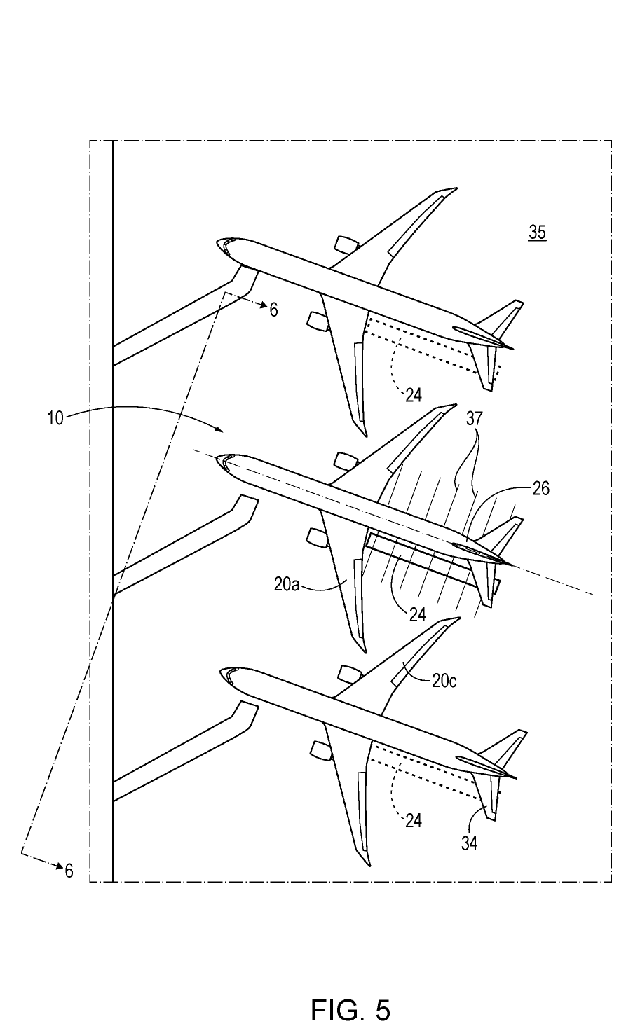

Height adjustment devices 24 may be configured to guide first aircraft 26 to transition first aircraft 26 from an entering position to a final position. For example, FIGS. 3-6 illustrate an example transition of a first aircraft 26 moving past, or being moved past, a second aircraft 34 using a height adjustment device 24, optionally at an angle to an airport gate 10 or airport terminal, rather than pulling in straight such that the aircraft is perpendicular to the airport gate. FIG. 3 shows first aircraft 26 in an entering position outside of airport gate 10, while FIG. 5 shows first aircraft 26 in a final position in airport gate 10. FIG. 4 shows an intermediate position during the transition between the entering position and the final position in which first aircraft 26 is parked at gate 10. With reference to FIG. 3, first aircraft 26 may taxi to position it on an approach line 40. In some examples, electric motors and sensors may be configured to determine the precise positioning of first aircraft 26 relative to approach line 40, height adjustment device 24, second aircraft 34, and/or gate 10. In the entering position, first aircraft 26 is not yet engaged with height adjustment device 24, and thus is not tilted and/or lifted with respect to second aircraft 34. As first aircraft 26 continues along approach line 40, it may be tilted and/or lifted by height adjustment device 24 to avoid interference between wing 20a of first aircraft 26 and wing 20c of second aircraft 34. As shown in FIG. 4, as first aircraft 26 passes second aircraft 34, wing 20a and wing 20c overlap, though they do not collide because height adjustment device 24 creates a vertical offset between wings 20a, 20c.

In some examples, height adjustment device 24 may be configured to tilt and/or lift one or both sides of the aircraft to varying degrees throughout the transition between the entering position and the final position. For example, first aircraft 26 may be tilted by a first amount (e.g., 4 degrees) in preparation for clearing wing 20c of second aircraft 34 adjacent to first aircraft 26, and then further tilted by a second amount (e.g., 8 degrees) as wing 20a passes over wing 20c. Generally, first aircraft 26 is tilted and/or lifted a sufficient amount such that an inboard section of first aircraft 26 clears the wing tip of second aircraft 34 by a predetermined threshold vertical offset. In other words, height adjustment device 24 may be configured to create a predetermined threshold vertical clearance between a first wing (e.g., wing 20a) of one aircraft (e.g., first aircraft 26) and an adjacent wing (e.g., wing 20c) of an adjacent aircraft (e.g., second aircraft 34). The predetermined threshold vertical clearance may be at least 1 inch, at least 3 inches, at least 5 inches, at least 7 inches, at least 10 inches, and/or at least 12 inches. Additionally or alternatively, the predetermined threshold vertical clearance may be selected based at least in part on a tolerance of wing flex of the wing of the aircraft (e.g., wing 20a of first aircraft 26) and of the adjacent wing of the adjacent aircraft (e.g., wing 20c of second aircraft 34). In some examples, the predetermined threshold vertical clearance is selected to be sufficient to withstand stacked tolerances, such as tolerances for wing flexing under a stiff wind, general wing flex, wind considerations, uneven pavement or ground surfaces at the airport, etc.

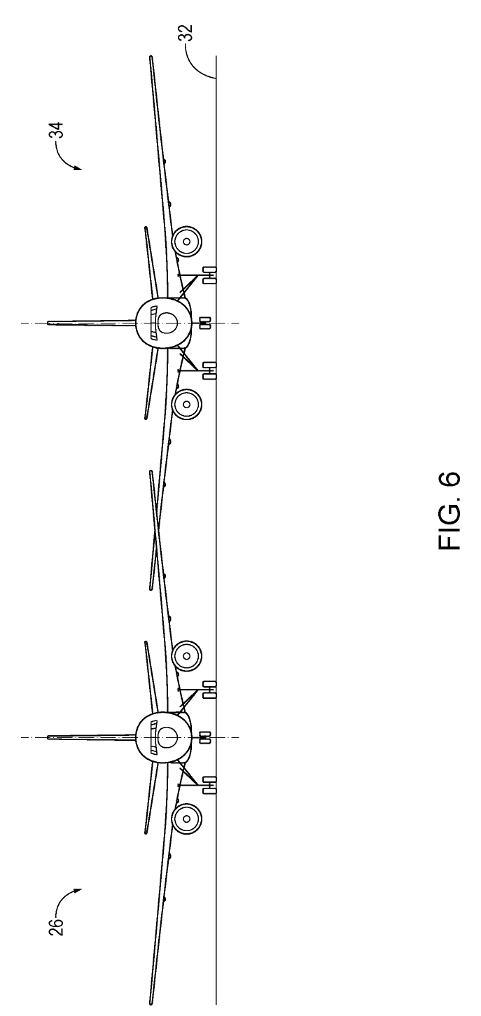

As first aircraft 26 further transitions towards the final position, the tilt and/or lift may be reduced. For example, the tilt angle of first aircraft 26 may be reduced to 6 degrees, then to 4 degrees, then to 2 degrees, and/or to zero degrees as it transitions to the final position shown in FIG. 5 in which wing 20a is now positioned past wing 20c and first aircraft 26 is parked in gate 10. Thus, height adjustment device 24 may be configured to tilt first aircraft 26 at a plurality of different tilt angles as first aircraft 26 moves between the entering position and the final position. In some examples, as shown in FIG. 6, height adjustment device 24 is configured to return first aircraft 26 to a level orientation in the final position.

Disclosed height adjustment devices 24 may advantageously be configured to improve aircraft efficiency and economics by enabling more efficient aircraft to enter the market without using wing folds. Certain examples of height adjustment devices 24 may enable avoidance of throttling the aircraft to position the aircraft on or otherwise into engagement with height adjustment device 24. The use of such height adjustment devices 24 may provide additional advantages, such as avoiding the increased costs and weight associated with the incorporation of wing folds in aircraft. Additionally or alternatively, disclosed height adjustment devices 24 may unblock sales of larger-span aircraft to customers heavily invested in existing limited infrastructure or to gate-constrained airports by circumventing gate constraints that would otherwise limit the use of more efficient wider span aircraft.

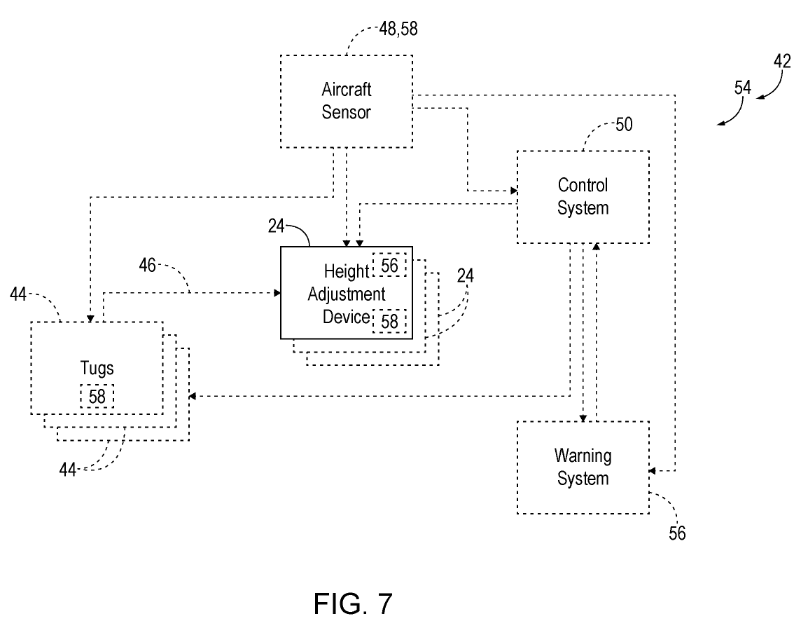

FIG. 7 is a schematic black box diagram illustrating non-exclusive examples of systems 42 according to the present disclosure that include one or more height adjustment devices 24. In some examples, system 42 includes a plurality of height adjustment devices 24. For example, system 42 may include a plurality of different types and/or sizes of height adjustment devices 24, each of which may be spaced apart in a plurality of different locations (e.g., different airport gates) of an airport. Some systems 42 include a plurality of different types, sizes, and/or configurations of height adjustment devices 24, such as including a different height adjustment device 24 for each different type of aircraft utilizing the airport. Aspects of system 42 and/or height adjustment devices 24 may be mobile and/or autonomous, and may be configured to park or position a first aircraft in a first gate or area, and then, once the first aircraft has cleared any adjacent aircraft or other obstacles, height adjustment device 24 may move to or be moved to a second gate or area to park or position a second aircraft, and so on. In this manner, a given height adjustment device 24 may service a plurality of different gates or areas within an airport or other space.

Additionally or alternatively, a plurality of height adjustment devices 24 may be used to lift and/or tilt a plurality of adjacent aircraft. For example, a first height adjustment device 24 may be configured to lift and/or tilt a first aircraft, and a second height adjustment device 24 may be configured to lift and/or tilt a second aircraft. To this end, two or more height adjustment devices 24 of system 42 may be configured to be coordinated with one another, or complement one another, such as by tilting two adjacent aircraft away from each other to increase the vertical clearance compared to tilting only one of the aircraft, and/or two height adjustment devices 24 may be coordinated to engage with a single aircraft at the same time. In some examples, adjacent aircraft may be lifted to a greater or lesser extent than one another, and/or adjacent aircraft may be tilted to a greater or lesser extent than one another. In one specific example, a first aircraft may be tilted by at least about 6 degrees, while a second aircraft may be tilted by about 2 degrees, while one of the aircraft is moved past the other, such as in instances where the second aircraft is parked at a second airport gate, and the first aircraft is entering a first airport gate adjacent the second airport gate. In other words, some systems 42 or height adjustment devices 24 are configured to tilt and/or lift just the moving aircraft or just the parked aircraft while the moving aircraft is moved past the adjacent parked aircraft, while some systems 42 or height adjustment devices 24 are configured to tilt and/or lift both the moving aircraft and the adjacent parked aircraft simultaneously.

Some systems 42 include a tug, or pushback tractor, 44 configured to move height adjustment device(s) 24 to a desired location, position, and/or orientation. For example, one or more height adjustment devices 24 may be mobile within an airport or airport gate location, and tug 44 may be used to position height adjustment device 24 for an incoming aircraft, to move height adjustment device 24 out of the way when a smaller wingspan aircraft is using the gate, to switch out one size or type of height adjustment device 24 for a different size or type of height adjustment device 24, and/or to move height adjustment device 24 to a different airport gate to transition an aircraft in a different location from its entering position to its final position. Additionally or alternatively, one or more tugs 44 may be configured to position an aircraft on height adjustment device 24 (or otherwise engage the aircraft with height adjustment device 24), and/or to push back the aircraft when height adjustment device 24 is not in use. In some examples, a communication link 46 between height adjustment device 24 and one or more tugs 44 may be configured to enable tug 44 to move an aircraft relative to height adjustment device 24, such as to pull the aircraft onto and/or into engagement with height adjustment device 24, and/or to push the aircraft off of or out of engagement with height adjustment device 24.

Some systems 42 include a control system 50 configured to position one or more height adjustment devices 24 relative to each other and/or relative to one or more aircraft. For example, control system 50 may be configured to track which types of aircraft are located at which gates throughout the airport, which type or size of height adjustment device 24 is needed to enable a given aircraft to be parked in a given airport gate (taking into consideration the wingspan of the aircraft, the gate size, and the wingspan of adjacent aircraft parked at adjacent airport gates), and therefore determine the desired position of one or more height adjustment devices 24. Additionally or alternatively, control system 50 may be configured to adjust a height, tilt angle, or other setting of height adjustment device 24, in response to the needs of an incoming aircraft relative to the constraints of the airport environment and adjacent aircraft. In this manner, control system 50 may be configured to prevent collisions between the aircraft, the adjacent aircraft, and/or one or more components of system 42 or height adjustment device 24 itself. In some examples, control system 50 may be configured such that system 42 and/or height adjustment device 24 is autonomous and/or automated. Control system 50 may be configured to communicate with (e.g., send and/or receive information to/from) and/or control height adjustment devices 24, tugs 44, and/or one or more sensors 58 of system 42.

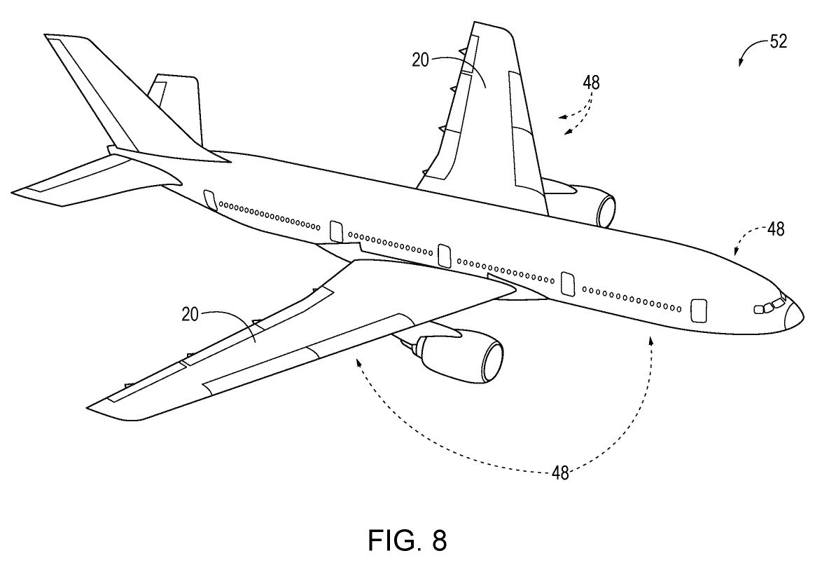

For example, system 42 may include one or more sensors 58 integrated into, coupled to, and/or in wireless communication with height adjustment devices 24 and/or tugs 44. Sensors 58 may include a variety of sensors as will be understood by those skilled in the art, and specifically may include one or more ultrasonic sensors in some examples. At least one aircraft sensor 48 (which is an example of sensor 58) may be positioned on or within the aircraft engaging with height adjustment device 24. Aircraft sensor 48 may be configured to measure and/or provide information regarding the height, orientation, and/or position of one or more points on the aircraft, and/or to measure or provide information regarding a distance between one or more points on the aircraft and an/the adjacent aircraft or other object within proximity to the aircraft or height adjustment device 24, in order to facilitate positioning of the aircraft with respect to an engagement surface of height adjustment device 24. Aircraft sensors 48 may include radio frequency communication capabilities such that they may be configured to send and/or receive information with control system 50. FIG. 8 schematically illustrates an aircraft 52 that includes one or more components of system 42, such as one or more aircraft sensors 48 configured to interact with height adjustment device 24.

Additionally or alternatively, sensors 58 may include a ground sensor positioned in or on a ground surface on which the aircraft is supported (e.g., ground surface 32), to facilitate positioning of the aircraft with respect to an engagement surface of height adjustment device 24, a floor sensor positioned in or on a floor surface on which the aircraft is supported, to facilitate positioning of the aircraft with respect to the engagement surface of height adjustment device 24, and/or a fail safe stop sensor configured to stop movement of the aircraft via height adjustment device 24 if an impending collision is detected.

Systems 42 also may include a warning system 56. Components of, or warning system 56 itself, may be integrated into height adjustment devices 24, and/or may be separate components configured to wirelessly communicate with tugs 44, height adjustment devices 24, aircraft sensors 48, and/or control system 50. Warning system 56 is generally configured to detect potential collisions between the aircraft and a second aircraft or other object, and may be further configured to warn flight crew, alert ground crew, engage an auto-brake, and/or actuate tilting of the aircraft in response to any detected potential collisions. Various examples of warning systems 56 may include lights, flashing lights, sounds, wireless communication, and/or navigation systems. In some examples, sensors 58 may communicate with warning system 56 to engage auto-brakes if needed to prevent potential collisions.

With reference again to FIG. 7, a kit 54 may include a plurality of height adjustment devices 24. For example, a first height adjustment device 24 of kit 54 may be configured to engage a first type of aircraft, while a second height adjustment device 24 of kit 54 may be configured to engage a second (e.g., different) type of aircraft. Kit 54 therefore may include different types and/or sizes of height adjustment devices to accommodate different types of aircraft, and/or different arrangements or gate sizes at a given airport, such that different height adjustment devices 24 may be deployed from kit 54 as needed in different situations occurring at the airport (e.g., different combinations of adjacent types of aircraft to be parked next to each other). As another example, one or more height adjustment devices 24 of kit 54 may be configured for use in a first arrangement of adjacent aircraft types, and at least one or more other height adjustment devices 24 of kit 54 may be configured for use in a second arrangement of adjacent aircraft types, wherein the second arrangement is different from the first arrangement. One or more height adjustment devices 24 of kit 54 may be adjustable in height to accommodate different a plurality of different types of aircraft. Generally, systems 42, kits 54, and/or height adjustment devices 24 may be used to create vertical clearance between wings of adjacent aircraft, and/or to enable a pair of aircraft to be parked in adjacent airport gates when each respective airport gate of the adjacent airport gates is narrower that a respective wingspan of each respective aircraft of the pair of aircraft, without needing to utilize aircraft with wing folds.

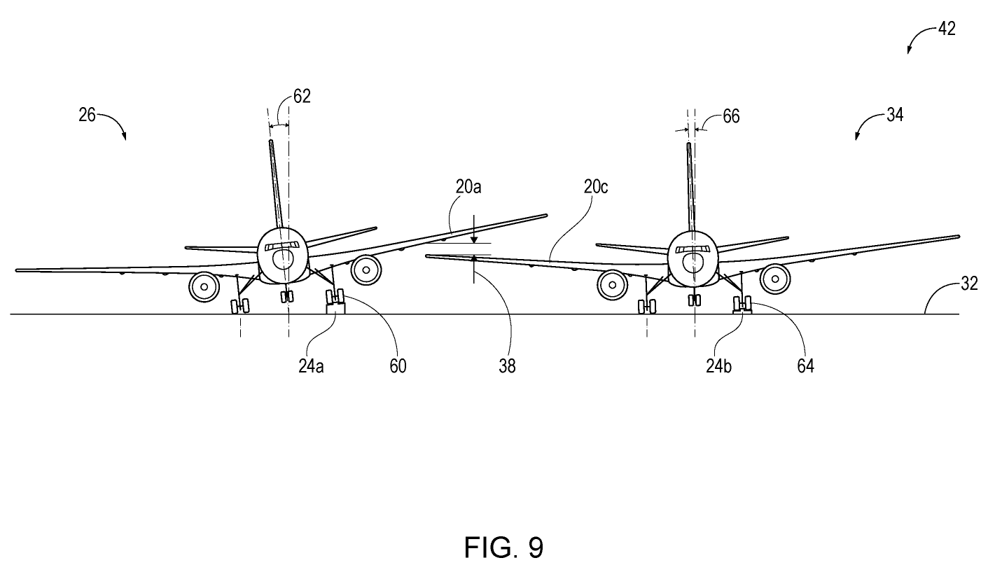

FIG. 9 schematically illustrates an example of system 42 having a plurality of height adjustment devices 24, in which a first height adjustment device 24a of the plurality of height adjustment devices 24 tilts a first aircraft 26, while a second height adjustment device 24b tilts a second aircraft 34. In the example of FIG. 9, first height adjustment device 24a is engaged with a first landing gear 60 on the left side of first aircraft 26 to tilt first aircraft 26 by a first tilt angle 62, thereby increasing the distance between wing 20a and ground surface 32. At the same time, second height adjustment device 24b is engaged with a second landing gear 64 on the left side of second aircraft 34 to tilt second aircraft 34 by a second tilt angle 66, such that wing 20c of second aircraft 34 is moved away from wing 20a of first aircraft 26 and towards ground surface 32. In other words, height adjustment devices 24a, 24b may be arranged with respect to adjacent aircraft 26, 34 such that adjacent wings 20a, 20c are tilted in opposite directions (e.g., wing 20a being tilted up away from ground surface 32, and wing 20c being tilted down towards ground surface 32), thereby increasing the vertical clearance between wings 20a, 20c. Height adjustment devices 24 may be configured to tilt the respective adjacent aircraft 26, 34 to differing degrees. For example, first aircraft 26 may be tilted to a greater extent than second aircraft 34 (e.g., first tilt angle 62 may be greater than second tilt angle 66). In a specific, non-limiting example, first tilt angle 62 may be around 6 degrees, and second tilt angle 66 may be around 2 degrees (e.g., for a stationary aircraft already positioned at the gate). Lower tilt angles may be preferred for aircraft during times when passengers are embarking or disembarking from the aircraft, while slightly larger tilt angles may be tolerated while the aircraft is in motion and passengers are seated and wearing their seat belts.

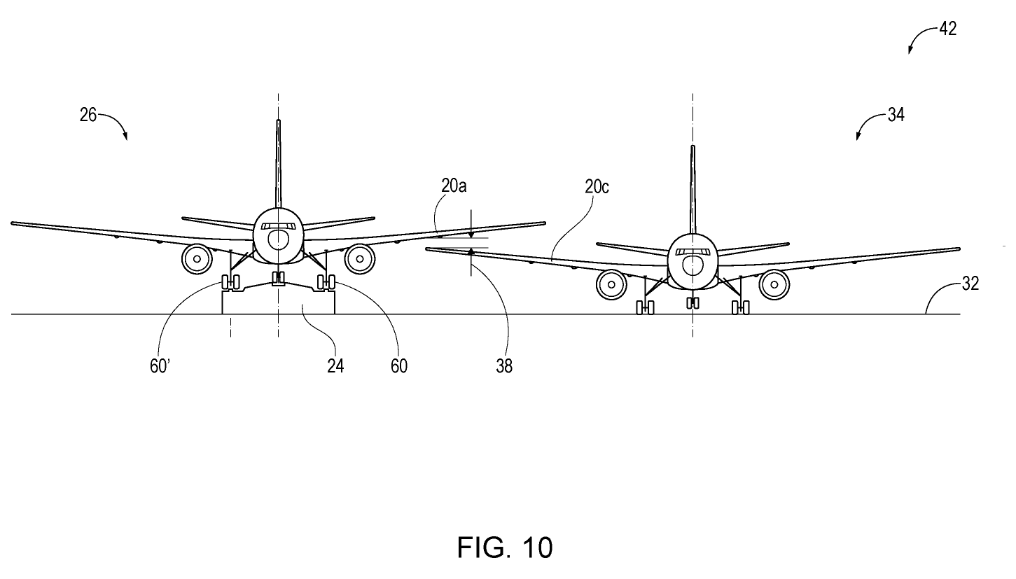

FIG. 10 schematically illustrates an example of system 42 having an example of height adjustment device 24 that is configured to lift, raise, or elevate a first aircraft 26 above ground surface 32 without tilting first aircraft 26. For example, height adjustment device 24 may include a ramp and/or utilize a pure vertical jacking motion to position first aircraft 26 above ground surface 32. In this example, first landing gear 60 on the left side of first aircraft 26 and first landing gear 60’ on the right side of first aircraft 26 are both engaged with (e.g., positioned on) height adjustment device 24. In this manner, the tilt angle is kept to zero, while still creating a vertical offset 38 between wing 20a of first aircraft 26 and wing 20c of an adjacent aircraft 34, such that first aircraft 26 may park next to and/or drive by adjacent aircraft 34 and/or such that second aircraft 34 may park next to and/or drive by first aircraft 26. In other words, height adjustment device 24 may be utilized with the parked or stationary aircraft while a second aircraft is moved past it, or height adjustment device 24 may be utilized with a moving aircraft as it is moved past a parked or stationary aircraft.

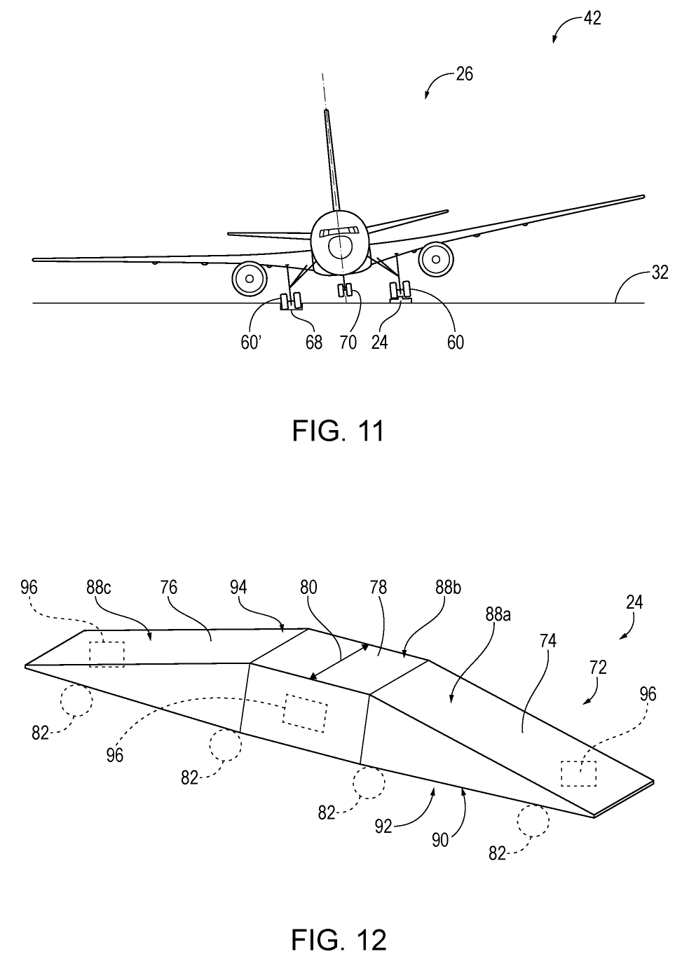

Disclosed height adjustment devices 24 may be used in combination with each other within given systems 42 (such as in the example of FIG. 9), and/or may be combined in systems 42 with one or more height adjustment devices that are integrated into airport infrastructure (e.g. integrated into ground surface 32). FIG. 11 schematically illustrates an example of system 42 that combines height adjustment devices 24 according to the present disclosure with a height adjustment device incorporated into ground surface 32, which is in the form of a trench 68 in this example. In the example shown in FIG. 11, landing gear 60 on the left side of aircraft 26 is engaged with (e.g., positioned on) height adjustment device 24, which tilts the left side of aircraft 26 away from ground surface 32, while landing gear 60’ on the right side of aircraft 26 is positioned within trench 68, which further tilts aircraft 26 such that the left side is moved away from ground surface 32 and the right side of aircraft 26 is moved towards ground surface 32. Such an arrangement may be configured to keep a nosewheel 70 of aircraft 26 at a normal (e.g., level) elevation/position on ground surface 32. Co-pending U.S. patent application titled HEIGHT ADJUSTMENT DEVICES, SYSTEMS INCLUDING THE SAME, AND METHODS FOR CREATING VERTICAL CLEARANCE BETWEEN WINGS OF ADJACENT AIRCRAFT and filed on Feb. 13, 2025, the entirety of which is incorporated by reference herein for all purposes, discloses height adjustment devices incorporated into airport infrastructure that may be used in conjunction with height adjustment devices 24 disclosed herein.

Turning now to FIGS. 12-20, illustrative non-exclusive examples of height adjustment devices 24 in the form of ramps 72 are illustrated. Where appropriate, the reference numerals from the schematic illustrations of FIGS. 2-11 are used to designate corresponding parts of ramps 72; however, the examples of FIGS. 12-20 are non-exclusive and do not limit height adjustment devices 24 to the illustrated embodiments of FIGS. 12-20. That is, height adjustment devices 24 are not limited to the specific embodiments of the illustrated ramps 72, and height adjustment devices 24 may incorporate any number of the various aspects, configurations, characteristics, properties, etc. that are illustrated in and discussed with reference to the schematic representations of FIGS. 2-11 and/or the embodiments of FIGS. 12-20, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to ramps 72; however, it is within the scope of the present disclosure that the previously discussed features, variants, etc. may be utilized therewith.

FIG. 12 illustrates an example of height adjustment device 24 in the form of a ramp 72, which may be configured to engage a main landing gear of an aircraft (e.g., landing gear 60 of first aircraft 26). Ramp 72 generally is configured to withstand a weight of the aircraft while the aircraft drives over or onto ramp 72. Ramp 72 may include a first angled portion 74, a second angled portion 76, and a level portion 78 positioned between first angled portion 74 and second angled portion 76. A width 80 of ramp 72 is sufficient to receive the main landing gear on at least one side of an aircraft which ramp 72 is configured to engage. As noted above, height adjustment device 24 may be mobile. For example, height adjustment device 24 may include a plurality of wheels 82 (e.g., caster wheels), which are schematically represented in FIG. 12, configured to allow movement of height adjustment device 24 along a ground surface or a floor surface relative to the aircraft. In this manner, height adjustment devices 24 may be moved to line up with the landing gear of an approaching aircraft. Wheels 82 may be configured to be retracted when not in use and extended when in use. In some examples, wheels 82 are powered and/or steerable. In some examples, systems (e.g., systems 42) may include a plurality of ramps 72, such as a first ramp to engage a right-hand side main landing gear of the aircraft, and a second ramp configured to engage a left-hand side main landing gear of the aircraft.

Ramp 72 may include a first ramp upper skin 88a extending along first angled portion 74, a constant upper skin 88b extending along level portion 78, and a second ramp upper skin 88c extending along second angled portion 76. First ramp upper skin 88a, constant upper skin 88b, and second ramp upper skin 88c, which together may be referred to simply as upper skin 88, may be integrally formed with each other such that they are a monolithic skin structure, or may be separate skins coupled together. Ramp 72 also may include a lower skin 90 that extends along a lower surface 92 of ramp 72, with lower skin 90 extending underneath first angled portion 74, second angled portion 76, and level portion 78. Lower surface 92 of ramp is opposite an engagement surface 94 of ramp 72. Engagement surface 94 may be defined by upper skin 88 and is the portion of ramp 72 that engages the aircraft. Ramp 72 is configured to receive at least a portion of the aircraft (e.g., on engagement surface 94) and then actively or passively lift the aircraft up off of a ground surface or a floor surface on which ramp 72 is positioned. Ramp 72 may include one or more ramp sensors 96 (which may be an example of sensors 58; ramp sensors 96 are schematically represented in FIG. 12) positioned on or within ramp 72, and configured to facilitate positioning of the aircraft with respect to engagement surface 94.

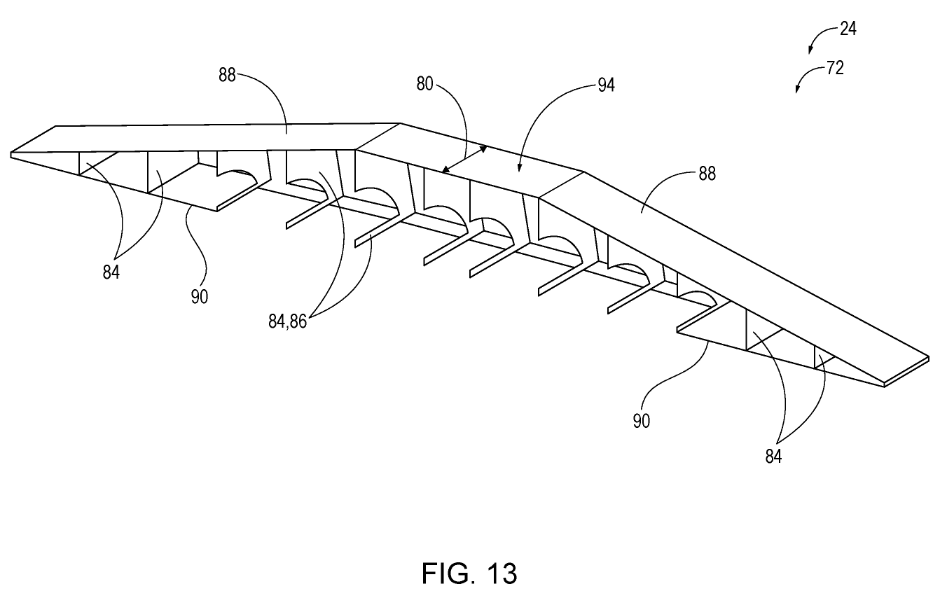

FIGS. 13-14 illustrate examples of internal structures of ramps 72 according to the present disclosure. For example, ramp 72 may include one or more stiffening and/or supporting members 84 extending across width 80 of ramp 72. In some examples, stiffening or supporting members 84 include one or more arches 86. Stiffening or supporting members 84 may extend from upper skin 88 to lower skin 90. Other examples of ramp 72 or height adjustment device 24 generally may include more or fewer stiffening or supporting members 84 than are illustrated in FIGS. 13-14, and/or may include different types of stiffening or supporting members 84. In some examples, the inclusion of stiffening or supporting members 84 may enable use of a thinner and/or lighter upper and/or lower skin 88, 90. The design of ramp 72 has many suitable design options which will be apparent to those of ordinary skill in the art.

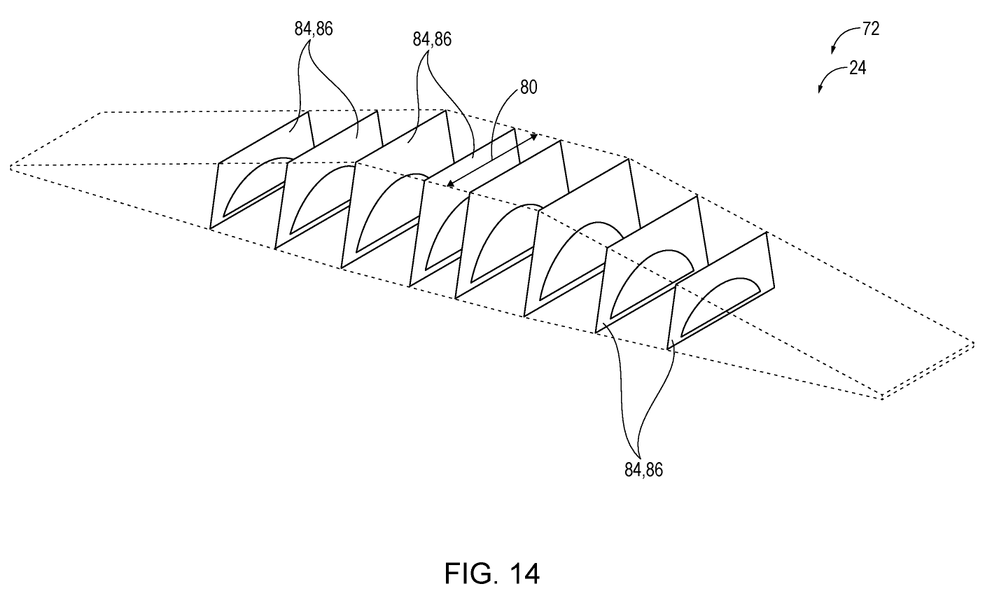

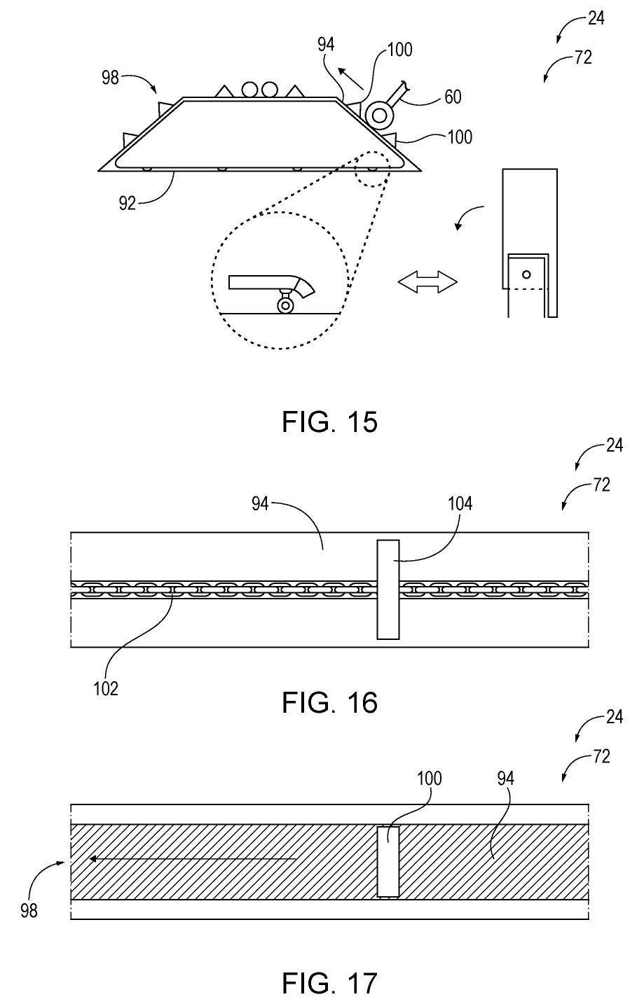

FIGS. 15-19 illustrate variations that may be incorporated into ramps 72 or other height adjustment devices 24 disclosed herein. For example, as shown in FIG. 15, ramp 72 may include a conveyor belt 98 that engages main landing gear 60 on one or both sides of the aircraft. In some examples, conveyor belt 98 may extend along and/or form at least a part of engagement surface 94. Conveyor belt 98 may include a plurality of backstops 100 configured to keep the wheels of main landing gear 60 from rolling down angled portions 74, 76 of ramp 72. The spacing of backstops 100 may be sized to accommodate multi-wheel landing gear. In some examples, conveyor belt 98 is powered, such that ramp 72 effectively grabs the wheels of the landing gear and aircraft power is not needed to move the aircraft up ramp 72. The callout shown in FIG. 15 illustrates folded and unfolded configurations of backstops 100, in which may be hinged such that they unfold as they progress along conveyor belt 98, but still allow aircraft trucks to cross over and unfold, with gravity and/or a low tension spring. To aid in a more compact design, backstops 100 may be configured to fold as they travel underneath the conveyor or ramp 72.

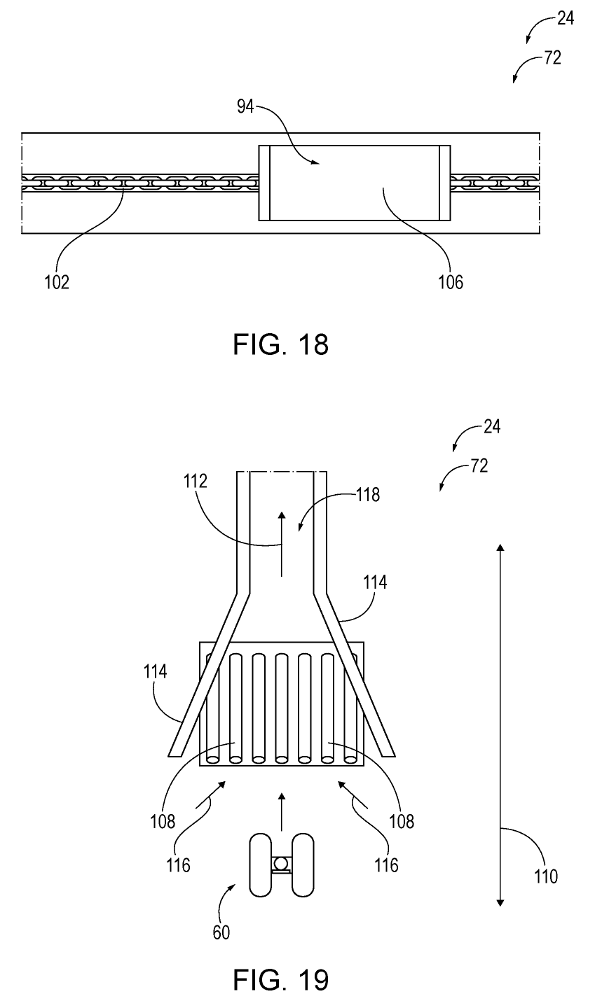

FIG. 16 illustrates an example of engagement surface 94 for ramp 72 that includes a chain-driven mechanism 102 that engages the main landing gear on one or both sides of the aircraft. For example, one or more roller wheels 104 may serve as a wheel stop for the main landing gear as chain-driven mechanism 102 pulls the aircraft up onto ramp 72. FIG. 17 illustrates an example of a conveyor belt 98 with a backstop 100 that may engage the landing gear of the aircraft. FIG. 18 illustrates an example of an engagement surface 94 in which a chain-driven mechanism 102 includes a chain-driven plate 106 on which the main landing gear on one or both sides of the aircraft is positioned while the aircraft is engaged with height adjustment device 24. FIG. 19 illustrates an example of height adjustment device 24 in the form of ramp 72 having a plurality of rollers 108 having a longitudinal axis 110 aligned with a desired direction of travel (indicated by arrow 112) of a main landing gear 60 of the aircraft. The plurality of rollers 108 may be configured to laterally align (indicated by arrows 116) landing gear 60 with a desired location, and/or within angled wall guides 114 of height adjustment device 24 (which may be a ramp 72 or other height adjustment device 24), such that landing gear 60 is directed onto or into a desired portion 118 of height adjustment device 24.

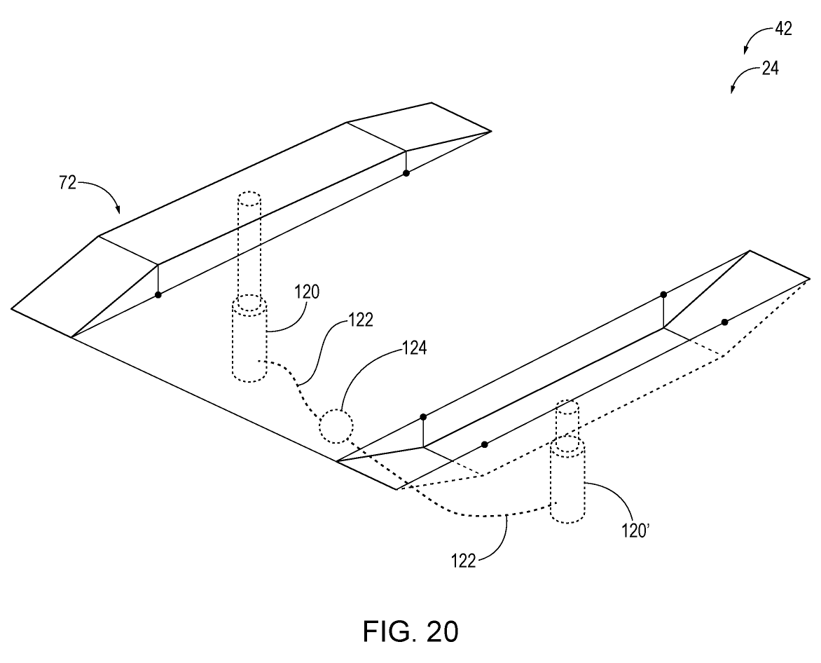

FIG. 20 schematically illustrates an example of system 42 in which height adjustment device 24 includes at least one actuating piston 120 configured to act on a main gear strut of an aircraft, with actuating piston 120 being configured to selectively and reversibly change a height of the main gear strut by raising and lowering at least a portion of height adjustment device 24 (e.g., by raising and lowering ramp 72). In some examples, a first actuating piston 120 is configured to act on a first main gear strut of the aircraft, while a second actuating piston 120’ is configured to act on a second main gear strut of the aircraft. An interconnect 122 between first actuating piston 120 and second actuating piston 120’ may be configured to leverage first actuating piston 120 and second actuating piston 120’ to minimize power and energy required to adjust the height of the aircraft via height adjustment device 24. In some examples, an actuator or pump 124 may be used to actuate actuating pistons 120 and/or 120’. Additionally or alternatively, height adjustment device 24 may be configured such that a load pushing down on one side of height adjustment device 24 causes the other side to be pushed upwards. In some such examples, little to no power is needed to tilt the aircraft because gravity on one side may at least partially provide the power needed to raise or tilt the aircraft on the other side. Interconnect 122 may be mechanical, hydraulic, and/or pneumatic in various examples of height adjustment device 24 and/or system 42.

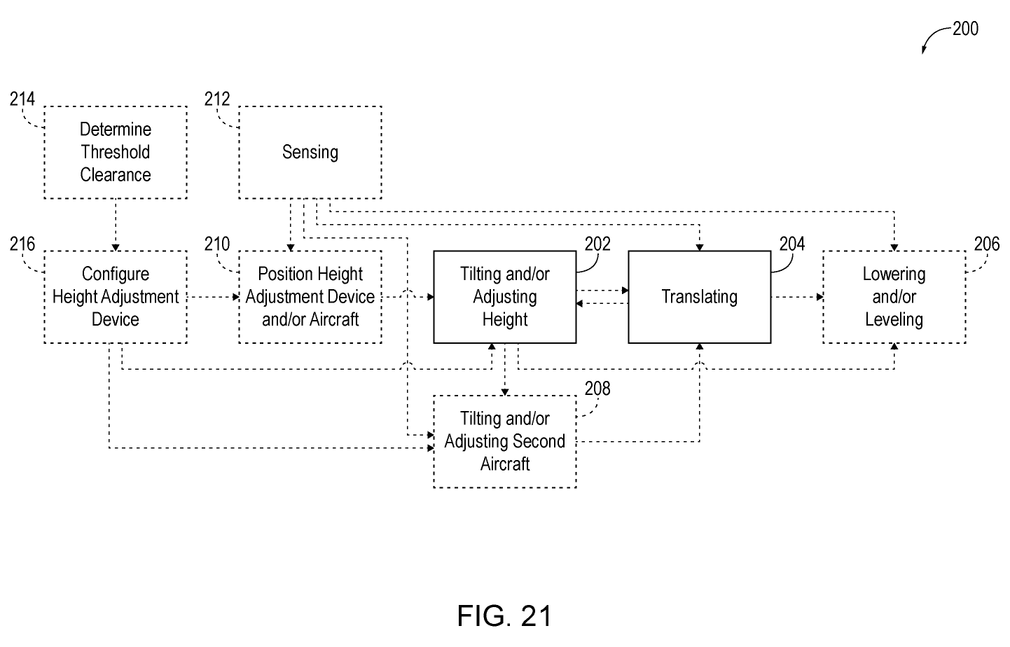

FIG. 21 schematically provides a flowchart that represents illustrative, non-exclusive examples of methods 200 according to the present disclosure. In FIG. 21, some steps are illustrated in dashed boxes indicating that such steps may be optional or may correspond to an optional version of a method according to the present disclosure. That said, not all methods according to the present disclosure are required to include the steps illustrated in solid boxes. The methods and steps illustrated in FIG. 21 are not limiting and other methods and steps are within the scope of the present disclosure, including methods having greater than or fewer than the number of steps illustrated, as understood from the discussions herein.

Methods 200 of docking or parking or otherwise positioning an aircraft generally include tilting and/or adjusting a height of at least a portion of a first aircraft via a height adjustment device (e.g., height adjustment device 24) at 202, and translating the first aircraft with respect to one or more other aircraft while the first aircraft is engaged with the height adjustment device, at 204, such that the first aircraft is tilted or has an adjusted height while the first aircraft is moved with respect to the other (e.g., second) aircraft at 204. After translating the first aircraft to a desired or final position in which the first aircraft’s wings are clear of the adjacent aircraft(s)’ wing(s) at 204, the first aircraft may be leveled and/or lowered with respect to the other aircraft, at 206, such that the first aircraft may be parked at the airport gate in a level position and/or a position in which the first aircraft is not elevated above the ground surface of the airport or other location where the first aircraft is positioned. In this manner, methods 200 may enable parking the first aircraft in an airport gate adjacent to a second gate where the second aircraft is parked, wherein the respective wingspans of the aircraft relative to the gates’ sizes would not otherwise allow these aircraft to be parked next to each other because of wing interference without using disclosed height adjustment devices.

In some methods 200, translating the first aircraft at 204 includes transitioning the first aircraft from an entering position to a final position. In the entering position, the first aircraft is located outside of a first airport gate. In the final position, the first aircraft is parked within the first airport gate, the second aircraft is parked in a second airport gate adjacent to the first airport gate. A first wingspan of the first aircraft and a second wingspan of the second aircraft are such that the respective sizes of the first airport gate and the second airport gate relative to the first wingspan and the second wingspan would preclude parking the first aircraft at the first airport gate while the second aircraft is parked in the second airport gate without performing tilting and/or adjusting at 202.

Tilting and/or adjusting the height of the first aircraft at 202 may include tilting the first aircraft sufficiently such that an inboard section of the first aircraft clears a wing tip of the second aircraft while the first aircraft is translated past the second aircraft at 204. Additionally or alternatively, tilting and/or adjusting the height of the first aircraft at 202 may include tilting the first aircraft through a plurality of different tilt angles that increase from zero degrees to a maximum tilt angle, and then decrease again back to zero degrees. The maximum tilt angle is at least 2 degrees, at least 4 degrees, at least 6 degrees, and/or at least 8 degrees, in some methods 200. Methods 200 may include translating the first aircraft at 204 at the same time as tilting and/or adjusting the height of the first aircraft at 202 and/or lowering and/or leveling the first aircraft at 206. In a specific example, tilting and/or adjusting the height of the first aircraft at 202 includes tilting the first aircraft to a tilt angle of at least between 2-4 degrees while translating the first aircraft at 204, and then tilting the first aircraft to a tilt angle of at least between 6-8 degrees at 202 while continuing to translate the first aircraft at 204. After the first wing of the first aircraft has cleared a second wing of the second aircraft during the translating the first aircraft at 204, lowering and/or leveling the first aircraft at 206 may include decreasing the tilt angle of the first aircraft to less than 6 degrees (optionally while the first aircraft continues to be translated at 204, or once the aircraft has been parked or positioned at the final position), then lowering and/or leveling the first aircraft at 206 may include decreasing the tilt angle of the first aircraft to less than 4 degrees after decreasing the tilt angle to less than 6 degrees (optionally while the first aircraft continues to be translated at 204, or once the aircraft has been parked or positioned at the final position), then lowering and/or leveling the first aircraft at 206 may include decreasing the tilt angle of the first aircraft to less than 2 degrees after decreasing the tilt angle to less than 4 degrees (optionally while the first aircraft continues to be translated at 204, or once the aircraft has been parked or positioned at the final position), then lowering and/or leveling the first aircraft at 206 may include decreasing the tilt angle of the first aircraft to less about zero degrees after decreasing the tilt angle to less than 2 degrees (optionally while the first aircraft continues to be translated at 204, or once the aircraft has been parked or positioned at the final position).

In some examples, methods 200 include tilting and/or adjusting a second height of at least a portion of the second aircraft via a second height adjustment device, at 208, in addition to tilting and/or adjusting the height of the first aircraft at 202. Tilting and/or adjusting the heights of the first and/or second aircraft at 202 and/or 208 each may include lifting one or both sides of the respective aircraft. In some examples, height adjustment devices may work differently on different adjacent aircraft. For example, the first aircraft may be tilted at 202 and the second adjacent aircraft may be lifted at 208, or the first aircraft may be lifted at 202 and the second adjacent aircraft may be tilted at 208.

Methods 200 may further include positioning the height adjustment device to align an engagement surface (e.g., engagement surface 94) of the height adjustment device with a main landing gear on at least one side of the first aircraft, at 210. For example, a tug may be used to position the height adjustment device at 210, and/or the height adjustment device may be laterally aligned with the main landing gear of the aircraft. Additionally or alternatively, positioning the height adjustment device at 210 may include positioning the height adjustment device in a desired orientation and position in an airport, such as within an airport gate where the aircraft is to be parked. In some examples, positioning the height adjustment device at 210 is performed autonomously. Additionally or alternatively, positioning the height adjustment device at 210 may include moving the height adjustment device to a different gate of an airport.

Methods 200 may include sensing the position of the first aircraft at 212, which data may be used to pull or push the first aircraft onto or otherwise in engagement with the height adjustment device. For example, sensing the position of the first aircraft 212 may inform the positioning of the height adjustment device at 210, the tilting and/or lifting of the first aircraft at 202, the translating the first aircraft, at 204, and/or the lowering and/or leveling of the first aircraft at 206.

Additionally or alternatively, methods 200 may include determining a threshold vertical clearance between a first wing of the first aircraft and a second wing of the second aircraft at 214, and configuring the height adjustment device at 216 to provide the determined threshold vertical clearance between the first wing and the second wing during the translating the first aircraft with respect to the second aircraft at 204. In some examples, configuring the height adjustment device at 216 includes adjusting a device height of the height adjustment device such that the height adjustment device is configured to handle a different arrangement of the first aircraft and the second aircraft.

Illustrative, non-exclusive examples of inventive subject matter according to the present disclosure are described in the following enumerated paragraphs:

A1. A height adjustment device (24) configured to temporarily and selectively adjust a height of at least a portion of an aircraft (26) while the aircraft (26) is engaged with the height adjustment device (24).

A2. The height adjustment device (24) of paragraph A1, wherein the height adjustment device (24) is configured to adjust a vertical distance (28) between a point (30) on a wing (20) of the aircraft (26) and a ground surface (32) or a floor surface on which a portion of the aircraft (26) is positioned when the aircraft (26) is engaged with the height adjustment device (24).

A3. The height adjustment device (24) of any of paragraphs A1-A2, wherein the height adjustment device (24) is configured to tilt the aircraft (26) such that a first wing (20a) of the aircraft (26) is vertically offset from a second wing (20b) of the aircraft (26) while the aircraft (26) is engaged with the height adjustment device (24).

A4. The height adjustment device (24) of any of paragraphs A1-A3, wherein the height adjustment device (24) is configured to guide the aircraft (26) to transition the aircraft (26) from an entering position to a final position.

A5. The height adjustment device (24) of paragraph A4, wherein the entering position is outside of an airport gate parking area (10), wherein the final position is in the airport gate parking area (10).

A6. The height adjustment device (24) of paragraph A4 or A5, wherein the height adjustment device (24) is configured to return the aircraft (26) to a level orientation in the final position.

A7. The height adjustment device (24) of any of paragraphs A1-A6, wherein the height adjustment device (24) is configured to temporarily and selectively adjust the height of at least the portion of the aircraft (26) relative to a/the ground surface (32) or a/the floor on which a portion of the aircraft (26) is positioned when the aircraft (26) is engaged with the height adjustment device (24).

A8. The height adjustment device (24) of any of paragraphs A1-A7, wherein the height adjustment device (24) is configured to temporarily and selectively adjust the height of at least the portion of the aircraft (26) relative to a second aircraft (34) when the aircraft (26) is engaged with the height adjustment device (24).

A9. The height adjustment device (24) of any of paragraphs A1-A8, wherein the height adjustment device (24) is configured to prevent interference with an adjacent aircraft (34) while the aircraft (26) travels such that a first wing (20a) of the aircraft (26) passes by an adjacent wing (20c) of the adjacent aircraft (34).

A10. The height adjustment device (24) of any of paragraphs A1-A9, wherein the height adjustment device (24) is configured to tilt the aircraft (26) at a plurality of different tilt angles as the aircraft (26) moves between an/the entering position and a/the final position.

A11. The height adjustment device (24) of any of paragraphs A1-A10, wherein the height adjustment device (24) is configured to lift a first side of the aircraft (26), but not a second side of the aircraft (26) while the aircraft (26) is engaged with the height adjustment device (24).

A12. The height adjustment device (24) of any of paragraphs A1-A10, wherein the height adjustment device (24) is configured to lift both a right side and a left side of the aircraft (26) while the aircraft (26) is engaged with the height adjustment device (24).

A13. The height adjustment device (24) of any of paragraphs A1-A12, wherein the height adjustment device (24) is configured to provide sufficient vertical clearance to allow the aircraft (26) to park at an airport gate (10) that spaced more closely to an adjacent airport gate (10) than a wingspan of the aircraft (26).

A14. The height adjustment device (24) of any of paragraphs A1-A13, wherein the height adjustment device (24) is configured to tilt one side of the aircraft (26) while the aircraft (26) is engaged with the height adjustment device (24).

A15. The height adjustment device (24) of any of paragraphs A1-A14, wherein the height adjustment device (24) is configured to tilt both sides of the aircraft (26) while the aircraft (26) is engaged with the height adjustment device (24).

A16. The height adjustment device (24) of any of paragraphs A1-A15, wherein the height adjustment device (24) comprises a ramp (72) configured to engage a main landing gear (60) of the aircraft (26).

A17. The height adjustment device (24) of paragraph A16, wherein the ramp (72) comprises at least: a first ramp (72) configured to engage a right hand side main landing gear (60) of the aircraft (26); and a second ramp (72) configured to engage a left hand side main landing gear (60) of the aircraft (26).

A18. The height adjustment device (24) of any of paragraphs A1-A17, wherein a/the ramp (72) is configured to withstand a weight of the aircraft (26) while the aircraft (26) drives over the ramp (72).

A19. The height adjustment device (24) of any of paragraphs A1-A18, wherein a/the ramp (72) comprises a conveyor belt (98) that engages a/the main landing gear (60) on one side of the aircraft (26).

A20. The height adjustment device (24) of paragraph A19, wherein the conveyor belt (98) is powered, such that aircraft power is not needed to move the aircraft (26) up the ramp (72).

A21. The height adjustment device (24) of any of paragraphs A1-A20, wherein a/the ramp (72) comprises a chain-driven mechanism (102) that engages a/the main landing gear (60) on one side of the aircraft (26).

A22. The height adjustment device (24) of any of paragraphs A1-A21, wherein a/the ramp (72) comprises a chain-driven plate (102) on which a/the main landing gear (60) on one side of the aircraft (26) is positioned while the aircraft (26) is engaged with the height adjustment device (24).

A23. The height adjustment device (24) of any of paragraphs A1-A22, wherein the height adjustment device (24) is autonomous.

A24. The height adjustment device (24) of any of paragraphs A1-A23, wherein the height adjustment device (24) comprises at least one motor configured to operate the height adjustment device (24) such that the aircraft (26) passively engages with the height adjustment device (24).

A25. The height adjustment device (24) of any of paragraphs A1-A24, wherein the height adjustment device (24) comprises at least one sensor (58).

A25.1. The height adjustment device (24) of paragraph A25, wherein the at least one sensor (58) comprises at least one ultrasonic sensor.

A26. The height adjustment device (24) of paragraph A25 or A25.1, wherein the at least one sensor (58) comprises an aircraft sensor (48) configured to be positioned on the aircraft (26) to facilitate positioning of the aircraft (26) with respect to an engagement surface (94) of the height adjustment device (24).

A27. The height adjustment device (24) of paragraph A25 or A26, wherein the at least one sensor (58) comprises a ramp sensor (96) positioned on a/the ramp (72) of the height adjustment device (24) to facilitate positioning of the aircraft (26) with respect to a/the engagement surface (94) of the height adjustment device (24).

A28. The height adjustment device (24) of any of paragraphs A25-A27, wherein the at least one sensor (58) comprises a ground sensor positioned in or on a ground surface (32) on which the aircraft (26) is supported, to facilitate positioning of the aircraft (26) with respect to a/the engagement surface (94) of the height adjustment device (24).

A28.1. The height adjustment device (24) of any of paragraphs A25-A28, wherein the at least one sensor (58) comprises a floor sensor positioned in or on a floor surface on which the aircraft (26) is supported, to facilitate positioning of the aircraft (26) with respect to a/the engagement surface (94) of the height adjustment device (24).

A29. The height adjustment device (24) of any of paragraphs A1-A28.1, wherein the height adjustment device (24) comprises at least one jack or lift configured to vertically lift a portion of the aircraft (26) above a/the ground surface (32) or a/the floor surface supporting the aircraft (26).

A30. The height adjustment device (24) of any of paragraphs A1-A29, wherein the height adjustment device (24) is configured to elevate the entire aircraft (26) relative to a/the ground surface (32) or a/the floor surface supporting the aircraft (26).

A31. The height adjustment device (24) of any of paragraphs A1-A30, wherein the height adjustment device (24) comprises a control system (50) configured to prevent collisions between the aircraft (26), an/the adjacent aircraft (34), and/or one or more components of the height adjustment device (24).

A32. The height adjustment device (24) of any of paragraphs A1-A31, wherein the height adjustment device (24) is configured to tilt the aircraft (26) at a/the tilt angle of 0 degrees, up to about 1 degree, up to about 2 degrees, up to about 3 degrees, up to about 4 degrees, up to about 5 degrees, up to about 6 degrees, up to about 7 degrees, up to about 8 degrees, up to about 9 degrees, and/or up to about 10 degrees.

A33. The height adjustment device (24) of any of paragraphs A1-A32, wherein the height adjustment device (24) is configured to create a predetermined threshold vertical clearance between a first wing (20a) of the aircraft (26) and an/the adjacent wing (20c) of an/the adjacent aircraft (34).

A34. The height adjustment device (24) of paragraph A33, wherein the predetermined threshold vertical clearance is at least 1 inch, at least 3 inches, at least 5 inches, at least 7 inches, at least 10 inches, and/or at least a foot.

A35. The height adjustment device (24) of paragraph A33 or A34, wherein the predetermined threshold vertical clearance is selected based at least in part on a tolerance of wing flex of the wing (20a) of the aircraft (26) and of the adjacent wing (20c) of the adjacent aircraft (34).

A36. The height adjustment device (24) of any of paragraphs A1-A35, wherein the height adjustment device (24) is configured to accommodate different types of aircraft with different lengths of landing gear.

A37. The height adjustment device (24) of any of paragraphs A1-A36, wherein the height adjustment device (24) comprises a fail safe stop sensor configured to stop movement of the aircraft (26) via the height adjustment device (24) if an impending collision is detected.

A38. The height adjustment device (24) of any of paragraphs A1-A37, wherein the height adjustment device (24) comprises a plurality of caster wheels (104) configured to allow movement of the height adjustment device (24) along a/the ground surface (32) or a/the floor surface, relative to the aircraft (26).

A39. The height adjustment device (24) of paragraph A38, wherein the plurality of caster wheels (104) are configured to be retracted when not in use, and extended when in use.

A40. The height adjustment device (24) of paragraph A38 or A39, wherein the plurality of caster wheels (104) are powered and/or steerable.

A41. The height adjustment device (24) of any of paragraphs A1-A40, wherein the height adjustment device (24) is mobile

A42. The height adjustment device (24) of any of paragraphs A1-A41, wherein the height adjustment device (24) is configured to passively engage and align the aircraft (26).

A43. The height adjustment device (24) of any of paragraphs A1-A42, wherein the height adjustment device (24) is configured to actively engage and align the aircraft (26).

A44. The height adjustment device (24) of any of paragraphs A1-A43, wherein the height adjustment device (24) is configured to laterally align a/the main landing gear (60) of the aircraft (26).

A45. The height adjustment device (24) of any of paragraphs A1-A44, wherein the height adjustment device (24) comprises a plurality of rollers (108) having a longitudinal axis (110) aligned with a direction of travel of a/the main landing gear (60) of the aircraft (26), wherein the plurality of rollers (108) are configured to laterally align the landing gear (60) with a desired location, or within angled wall guides (114) of the height adjustment device (24).

A46. The height adjustment device (24) of any of paragraphs A1-A45, wherein the height adjustment device (24) is configured to adjust the height of the aircraft (26) relative to a/the ground surface (32) or a/the floor surface without tilting the aircraft (26).

A47. The height adjustment device (24) of any of paragraphs A1-A46, wherein the height adjustment device (24) is adjustable such that the height adjustment device (24) is configured to adjust the aircraft (26) to a plurality of different heights.

A48. The height adjustment device (24) of any of paragraphs A1-A47, wherein the height adjustment device (24) comprises a/the ramp (72), wherein the ramp (72) comprises:

a first angled portion (74);

a second angled portion (76); and

a level portion (78) positioned between the first angled portion (74) and the second angled portion (76), wherein a width (80) of the ramp (72) is sufficient to receive a/the main landing gear (60) on one side of the aircraft (26).

A49. The height adjustment device (24) of any of paragraphs A1-A48, wherein a/the ramp (72) of the height adjustment device (24) comprises one or more stiffening and/or supporting members (84).

A50. The height adjustment device (24) of any of paragraphs A48-A49, wherein the ramp (72) comprises a first ramp upper skin (88a) extending along the first angled portion (74), a constant upper skin (88b) extending along the level portion (78), and a second ramp upper skin (88c) extending along the second angled portion (76).

A51. The height adjustment device (24) of paragraph A50, wherein the first ramp upper skin (88a), the second ramp upper skin (88c), and the constant upper skin (88b) are integrally formed such that they are a monolithic skin structure.

A52. The height adjustment device (24) of any of paragraphs A48-A51, wherein the ramp (72) comprises a lower skin (90) that extends along a lower surface (92) of the ramp (72), wherein the lower skin (90) extends underneath the first angled portion (74), the second angled portion (76), and the level portion (78), and wherein the lower surface (92) of the ramp (72) is opposite a/the engagement surface (94) of the ramp (72).

A53. The height adjustment device (24) of any of paragraphs A1-A52, wherein the height adjustment device (24) comprises a/the ramp (72), and wherein the ramp (72) is configured to receive at least a portion of the aircraft (26) and then actively lift the aircraft (26) up off of a/the ground surface (32) or a/the floor surface on which the height adjustment device (24) is positioned.

A54. The height adjustment device (24) of any of paragraphs A1-A53, wherein the height adjustment device (24) comprises at least one actuating piston (120) configured to act on a main gear strut of the aircraft (26), wherein the at least one actuating piston (120) is configured to selectively and reversibly change a height of the main gear strut.

A55. The height adjustment device (24) of any of paragraphs A1-A54, wherein the height adjustment device (24) comprises:

a first actuating piston (120) configured to act on a first main gear strut of the aircraft (26);

a second actuating piston (120’) configured to act on a second main gear strut of the aircraft (26); and

an interconnect (122) between the first actuating piston (120) and the second actuating piston (120’), wherein the interconnect (122) is configured to leverage the first actuating piston (120) and the second actuating piston (120’) to minimize power and energy required to adjust the height of the aircraft (26).

A56. The height adjustment device (24) of paragraph A55, wherein the interconnect (122) is mechanical, hydraulic, and/or pneumatic.

A57. The height adjustment device (24) of any of paragraphs A1-A56, wherein the height adjustment device (24) comprises a warning system configured to detect potential collisions between the aircraft (26) and a second aircraft (34) or other object, and wherein the warning system is further configured to warn flight crew, alert ground crew, engage an auto-brake, and/or actuate tilting of the aircraft (26) in response to any detected potential collisions.

A58. The height adjustment device (24) of paragraph A57, wherein the warning system comprises lights, flashing lights, sounds, wireless communication, and/or navigation systems.

B1. A system (42) for close gate spacing of large span aircraft, the system (42) comprising the height adjustment device (24) of any of paragraphs A1-A58.

B2. The system (42) of paragraph B1, comprising a plurality of height adjustment devices (24), each height adjustment device (24) of the plurality of height adjustment devices (24) being the height adjustment device (24) of any of paragraphs A1-A58.

B3. The system (42) of paragraph B2, wherein the plurality of height adjustment devices (24) comprises a plurality of different types and/or sizes of height adjustment devices (24).

B4. The system (42) of paragraph B2 or B3, wherein the plurality of height adjustment devices (24) are spaced apart in a plurality of different locations of an airport.

B5. The system (42) of any of paragraphs B2-B4, further comprising a tug (44), or pushback tractor, configured to move the height adjustment device (24) to a desired location, position, and/or orientation.

B6. The system (42) of paragraph B5, wherein the tug (44) is a first tug (44), wherein the system (42) further comprises a second tug (44), wherein the first tug (44) is configured to position the aircraft (26) on the height adjustment device (24), and wherein the second tug (44) is configured for pushing back the aircraft (26) when the height adjustment device (24) is not in use.

B7. The system (42) of any of paragraphs B1-B6, further comprising a control system (50) configured to position one or more height adjustment devices (24) relative to each other and/or relative to the aircraft (26).

B8. The system (42) of any of paragraphs B1-B7, further comprising at least one aircraft sensor (48) positioned on or within the aircraft (26), wherein the at least one aircraft sensor (48) is configured to measure and/or provide information regarding the height, orientation, and/or position of one or more points on the aircraft (26), and/or to measure or provide information regarding a distance between one or more points on the aircraft (26) and an/the adjacent aircraft (34) or other object.

B9. The system (42) of any of paragraphs B1-B8, wherein the height adjustment device (24) is mobile and wherein the system (42) is automated and/or autonomous.

B10. The system (42) of any of paragraphs B1-B9, further comprising a communication link (46) between the height adjustment device (24) and one or more tugs (44) configured to move the aircraft (26) relative to the height adjustment device (24).

B11. The system (42) of any of paragraphs B1-B10, wherein the height adjustment device (24) comprises a first height adjustment device (24), and wherein the system (42) further comprises a second height adjustment device (24), wherein the second height adjustment device (24) is the height adjustment device (24) of any of paragraphs A1-A58.

B12. The system (42) of paragraph B11, wherein the first height adjustment device (24) is configured to tilt a first aircraft (26), and wherein the second height adjustment device (24) is configured to tilt a second aircraft (34).

B13. The system (42) of paragraph B12, wherein the first height adjustment device (24) is configured to tilt the first aircraft (26) at a first angle (62), and wherein the second height adjustment device (24) is configured to tilt the second aircraft (34) at a second angle (66).

B14. The system (42) of paragraph B13, wherein the first angle (62) is greater than the second angle (66).

B15. The system (42) of paragraph B14, wherein the first angle (62) is at least about 6 degrees, and wherein the second angle (66) is about 2 degrees.

B16. The system (42) of any of paragraphs B13-B15, wherein the second aircraft (34) is parked at a second airport gate (10), and wherein the first aircraft (26) is entering a first airport gate (10) adjacent the second airport gate (10).

C1. A kit (54), comprising a plurality of height adjustment devices (24), each height adjustment device (24) of the plurality of height adjustment devices (24) being the height adjustment device (24) of any of paragraphs A1-A58.

C2. The kit (54) of paragraph C1, wherein at least a first height adjustment device (24) of the plurality of height adjustment devices (24) is configured to engage a first type of aircraft, wherein at least a second height adjustment device (24) of the plurality of height adjustment devices (24) is configured to engage a second type of aircraft, and wherein the first type of aircraft is different from the second type of aircraft.

C3. The kit (54) of paragraph C1 or C2, wherein at least one height adjustment device (24) of the plurality of height adjustment devices (24) is configured for use in a first arrangement of adjacent aircraft types, and wherein at least one height adjustment device (24) of the plurality of height adjustment devices (24) is configured for use in a second arrangement of adjacent aircraft types, wherein the second arrangement is different from the first arrangement.

D1. An aircraft (26) comprising the height adjustment device (24) of any of paragraphs A1-A58 and/or one or more components of the system (42) of any of paragraphs B1-B16.

D2. An aircraft (26) comprising one or more sensors (58) configured to interact with the height adjustment device (24) of any of paragraphs A1-A58.

E1. A method (200), comprising:

tilting and/or adjusting (202) a height of at least a portion of a first aircraft (26) via the height adjustment device (24) of any of paragraphs A1-A58; and

translating (204) the first aircraft (26) with respect to a second aircraft (34) while the first aircraft (26) is engaged with the height adjustment device (24), such that the first aircraft (26) is tilted or has an adjusted height while the first aircraft (26) is moved with respect to the second aircraft (34).

E2. The method (200) of paragraph E1, further comprising lowering (206) the first aircraft (26) after the translating (204) the first aircraft (26) with respect to the second aircraft (34).

E3. The method (200) of any of paragraphs E1-E2, further comprising leveling (206) the first aircraft (26) after the translating (204) the first aircraft (26) with respect to the second aircraft (34).

E4. The method (200) of any of paragraphs E1-E3, wherein the translating (204) the first aircraft (26) with respect to the second aircraft (34) is performed until a first wing (20a) of the first aircraft (26) is moved past a second wing (20c) of the second aircraft (34).

E5. The method (200) of any of paragraphs E1-E4, wherein the second aircraft (34) is parked in a second airport gate (10) during the translating (204) the first aircraft (26), and wherein the translating (204) the first aircraft (26) comprises parking the first aircraft (26) in a first airport gate (10) adjacent the second airport gate (10).

E6. The method (200) of any of paragraphs E1-E5, further comprising tilting and/or adjusting (208) a second height of at least a portion of the second aircraft (34) via a second height adjustment device (24) according to any of paragraphs A1-A58.

E7. The method (200) of any of paragraphs E1-E6, wherein the tilting and/or adjusting (202) the height comprises lifting one side of the first aircraft (26).

E8. The method (200) of any of paragraphs E1-E7, wherein the tilting and/or adjusting (202) the height comprises lifting both sides of the first aircraft (26).

E9. The method (200) of any of paragraphs E1-E8, wherein the tilting and/or adjusting (202) the height comprises tilting the first aircraft (26) and lifting the first aircraft (26) with respect to the second aircraft (34).

E10. The method (200) of any of paragraphs E1-E9, wherein the tilting and/or adjusting (202) the height comprises lifting the first aircraft (26) with respect to the second aircraft (34), and wherein the method (200) further comprises tilting (208) the second aircraft (34) during the translating (204) the first aircraft (26).

E11. The method (200) of any of paragraphs E1-E10, further comprising positioning (210) the height adjustment device (24) to align an/the engagement surface (94) of the height adjustment device (24) with a/the main landing gear (60) on at least one side of the first aircraft (26).

E11.1. The method (200) of paragraph E11, wherein the positioning (210) the height adjustment device (24) is performed using a tug (44).

E11.2. The method (200) of paragraph E11 or E11.1, wherein the positioning (210) the height adjustment device (24) is performed autonomously.

E12. The method (200) of any of paragraphs E1-E11.2, further comprising sensing (212) the position of the first aircraft (26) and pulling or pushing the first aircraft (26) onto the height adjustment device (24).

E13. The method (200) of any of paragraphs E1-E12, further comprising moving the height adjustment device (24) to a different gate (10) of an airport, wherein the first aircraft (26) is parked at the airport.

E14. The method (200) of any of paragraphs E1-E13, wherein the translating (204) the first aircraft (26) comprises transitioning the first aircraft (26) from an entering position to a final position, wherein in the entering position the first aircraft (26) is located outside of a first airport gate (10), wherein in the final position the first aircraft (26) is parked within the first airport gate (10), wherein the second aircraft (34) is parked in a second airport gate (10) adjacent to the first airport gate (10), and wherein a first wingspan of the first aircraft (26) and a second wingspan of the second aircraft (34) are such that the respective sizes of the first airport gate (10) and the second airport gate (10) relative to the first wingspan and the second wingspan would preclude parking the first aircraft (26) at the first airport gate (10) while the second aircraft (34) is parked in the second airport gate (10) without performing the tilting and/or adjusting (204).

E15. The method (200) of any of paragraphs E1-E14, wherein the tilting and/or adjusting (204) comprising tilting the first aircraft (26) sufficiently such that an inboard section of the first aircraft (26) clears a wing tip of the second aircraft (34) while the first aircraft (26) is translated past the second aircraft (34).

E16. The method (200) of any of paragraphs E1-E15, wherein the tilting and/or adjusting (204) comprises tilting the first aircraft (26) through a plurality of different tilt angles that increase from zero degrees to a maximum tilt angle, and then decrease again back to zero degrees.

E17. The method (200) of paragraph E16, wherein the maximum tilt angle is at least 2 degrees, at least 4 degrees, at least 6 degrees, and/or at least 8 degrees.

E18. The method (200) of any of paragraphs E1-E17, wherein the tilting and/or adjusting comprises:

tilting the first aircraft (26) to at least between 2-4 degrees;

tilting the first aircraft (26) to at least between 6-8 degrees;

decreasing a/the tilt angle of the first aircraft (26) to less than 6 degrees after a/the first wing (20a) of the first aircraft (26) has cleared a/the second wing (20c) of the second aircraft (34) during the translating the first aircraft (26);

decreasing the tilt angle of the first aircraft (26) to less than 4 degrees after decreasing the tilt angle to less than 6 degrees;

decreasing the tilt angle of the first aircraft (26) to less than 2 degrees after decreasing the tilt angle to less than 4 degrees; and

decreasing the tilt angle to about zero degrees after decreasing the tilt angle to less than 2 degrees.

E19. The method (200) of any of paragraphs E1-E18, further comprising:

determining (214) a threshold vertical clearance between a/the first wing (20a) of the first aircraft (26) and a/the second wing (20c) of the second aircraft (34); and

configuring (216) the height adjustment device (24) to provide the threshold vertical clearance between the first wing (20a) and the second wing (20c) during the translating (204) the first aircraft (26) with respect to the second aircraft (34).

E20. The method (200) of any of paragraphs E1-E19, further comprising adjusting a device height of the height adjustment device (24) such that the height adjustment device (24) is configured to handle a different arrangement of the first aircraft (26) and the second aircraft (34).

E21. The method (200) of any of paragraphs E1-E20, further comprising laterally aligning a/the main landing gear (60) of the aircraft (26) with the height adjustment device (24).

F1. The use of the height adjustment device (24) of any of paragraphs A1-A58 to create vertical clearance between wings of adjacent aircraft (26, 34).

F2. The use of the height adjustment device (24) of any of paragraphs A1-A58 to enable a pair of aircraft (26, 34) to be parked in adjacent airport gates (10), wherein each respective airport gate (10) of the adjacent airport gates (10) is narrower that a respective wingspan of each respective aircraft of the pair of aircraft (26, 34).

F3. The use of the height adjustment device (24) of any of paragraphs A1-A58 to even out sill heights of different sizes of aircraft.

F4. The use of the system (42) of any of paragraphs B1-B16 to create vertical clearance between wings (20) of adjacent aircraft (26, 34).

F5. The use of the system (42) of any of paragraphs B1-B16 to enable a pair of aircraft (26, 34) to be parked in adjacent airport gates (10), wherein each respective airport gate (10) of the adjacent airport gates (10) is narrower that a respective wingspan of each respective aircraft of the pair of aircraft (26, 34).

F6. The use of the system (42) of any of paragraphs B1-B16 to even out sill heights of different sizes of aircraft.

F7. The use of the kit (54) of any of paragraphs C1-C3 to create vertical clearance between wings (20) of adjacent aircraft (26, 34).

F8. The use of the kit (54) of any of paragraphs C1-C3 to enable a pair of aircraft (26, 34) to be parked in adjacent airport gates (10), wherein each respective airport gate (10) of the adjacent airport gates (10) is narrower that a respective wingspan of each respective aircraft of the pair of aircraft (26, 34).

F9. The use of the kit of any of paragraphs C1-C3 to even out sill heights of different sizes of aircraft.

A controller (e.g., control system 50) may be or include any suitable device or devices that are configured to perform the functions of the controller discussed herein. For example, the controller may include one or more of an electronic controller, a dedicated controller, a special-purpose controller, a personal computer, a special-purpose computer, a display device, a logic device, a memory device, and/or a memory device having computer readable media suitable for storing computer-executable instructions for implementing aspects of systems and/or methods according to the present disclosure.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

What is claimed is:

1. A height adjustment device configured to temporarily and selectively adjust a height of at least a first portion of a first aircraft while the first aircraft is engaged with the height adjustment device, the height adjustment device comprising:
a ramp configured to engage at least a first main landing gear on at least one side of the first aircraft, wherein the ramp comprises:
a first angled portion;
a second angled portion; and
a level portion positioned between the first angled portion and the second angled portion, wherein a width of the ramp is sufficient to receive the first main landing gear, wherein the height adjustment device is configured to guide the first aircraft to transition the first aircraft from an entering position to a final position.

2. The height adjustment device according to claim 1, wherein the height adjustment device is configured to adjust a vertical distance between a point on a wing of the first aircraft and a ground surface supporting the first aircraft when the aircraft is engaged with the height adjustment device.

3. The height adjustment device according to claim 1, wherein the height adjustment device is configured to tilt the first aircraft such that a first wing of the first aircraft is vertically offset from a second wing of the aircraft while the aircraft is engaged with the height adjustment device.

4. The height adjustment device according to claim 1, wherein the entering position is outside of an airport gate parking area, and wherein the final position is in the airport gate parking area.

5. The height adjustment device according to claim 1, wherein the height adjustment device is configured to position the first aircraft in a level orientation in the final position.

6. The height adjustment device according to claim 1, wherein the height adjustment device is configured to prevent interference with an adjacent aircraft while the first aircraft travels to the final position such that a first wing of the first aircraft passes by an adjacent wing of the adjacent aircraft.

7. The height adjustment device according to claim 1, wherein the height adjustment device is configured to lift both a right side and a left side of the first aircraft while the first aircraft is engaged with the height adjustment device, and wherein the ramp is configured to receive at least a portion of the first aircraft and then actively lift the first aircraft up off of a ground surface on which the height adjustment device is positioned.

8. The height adjustment device according to claim 1, wherein the height adjustment device is configured to provide sufficient vertical clearance to allow the first aircraft to park at an airport gate that spaced more closely to an adjacent airport gate than a wingspan of the first aircraft.

9. The height adjustment device according to claim 1, wherein the ramp comprises a conveyor belt that engages the first main landing gear of the first aircraft, wherein the conveyor belt is powered, such that the first aircraft does not use its own power to move the first aircraft up the ramp.

10. The height adjustment device according to claim 1, wherein the height adjustment device comprises:
at least one motor configured to operate the height adjustment device such that the first aircraft passively engages with the height adjustment device; and
at least one sensor configured to facilitate positioning of the first aircraft with respect to an engagement surface of the height adjustment device.

11. The height adjustment device according to claim 1, wherein the height adjustment device comprises at least one jack or lift configured to vertically lift a portion of the first aircraft above a ground surface supporting the first aircraft.

12. The height adjustment device according to claim 1, wherein the height adjustment device comprises a control system configured to prevent collisions between the first aircraft and an adjacent aircraft, and wherein the height adjustment device is configured to create a predetermined threshold vertical clearance between a first wing of the first aircraft and an adjacent wing of the adjacent aircraft.

13. The height adjustment device according to claim 1, wherein the height adjustment device comprises a plurality of caster wheels configured to allow movement of the height adjustment device relative to the first aircraft along a ground surface supporting the first aircraft, wherein the plurality of caster wheels are configured to be retracted when not in use and extended when in use.

14. The height adjustment device according to claim 1, wherein the height adjustment device comprises a plurality of rollers having a longitudinal axis aligned with a direction of travel of the main landing gear of the first aircraft, wherein the plurality of rollers are configured to laterally align the landing gear within angled wall guides of the height adjustment device.

15. The height adjustment device according to claim 1, wherein the height adjustment device comprises at least one actuating piston in a main gear strut of the first aircraft, wherein the at least one actuating piston is configured to selectively and reversibly change a height of the main gear strut.

16. The height adjustment device according to claim 1, wherein the height adjustment device comprises a warning system configured to detect potential collisions between the first aircraft and a second aircraft or other object, and wherein the warning system is further configured to warn flight crew, alert ground crew, engage an auto-brake, and/or actuate tilting of the aircraft in response to any detected potential collisions.

17. A kit, comprising a plurality of height adjustment devices, each height adjustment device of the plurality of height adjustment devices being the height adjustment device according to claim 1, wherein at least a first height adjustment device of the plurality of height adjustment devices is configured to engage a first type of aircraft, wherein at least a second height adjustment device of the plurality of height adjustment devices is configured to engage a second type of aircraft, and wherein the first type of aircraft is different from the second type of aircraft.

18. A system for close gate spacing of large span aircraft, the system comprising:
a plurality of height adjustment devices each configured to temporarily and selectively adjust a height of at least a first portion of a respective aircraft while the respective aircraft is engaged with a respective height adjustment device of the plurality of height adjustment devices, wherein the plurality of height adjustment devices are spaced apart in a plurality of different locations of an airport;
a plurality of tugs, each tug of the plurality of tugs being configured to position a respective aircraft on a respective height adjustment device of the plurality of height adjustment devices;
a control system configured to position one or more height adjustment devices relative to each other and relative to one or more aircraft;
at least one aircraft sensor positioned on or within the aircraft, wherein the at least one aircraft sensor is configured to measure and/or provide information regarding the height, orientation, and/or position of one or more points on the aircraft, and/or to measure or provide information regarding a distance between one or more points on the aircraft and an adjacent aircraft or other object.

19. A method, comprising:
adjusting a height of at least a portion of a first aircraft via a height adjustment device, wherein the height adjustment device comprises a ramp configured to engage at least a first main landing gear on at least one side of the first aircraft;
translating the first aircraft with respect to a second aircraft while the first aircraft is engaged with the height adjustment device, such that the first aircraft is tilted or has an adjusted height while the first aircraft is moved with respect to the second aircraft, wherein the translating the first aircraft with respect to the second aircraft is performed until a first wing of the first aircraft is moved past a second wing of the second aircraft; and
leveling the first aircraft after the translating the first aircraft with respect to the second aircraft.

20. The method according to claim 19, wherein the translating the first aircraft comprises transitioning the first aircraft from an entering position to a final position, wherein in the entering position the first aircraft is located outside of a first airport gate, wherein in the final position the first aircraft is parked within the first airport gate, wherein the second aircraft is parked in a second airport gate adjacent to the first airport gate, and wherein a first wingspan of the first aircraft and a second wingspan of the second aircraft are such that the respective sizes of the first airport gate and the second airport gate relative to the first wingspan and the second wingspan would preclude parking the first aircraft at the first airport gate while the second aircraft is parked in the second airport gate without performing the adjusting the height, and wherein the method further comprises:
determining a threshold vertical clearance between the first wing of the first aircraft and the second wing of the second aircraft; and
configuring the height adjustment device to provide the threshold vertical clearance between the first wing and the second wing during the translating the first aircraft with respect to the second aircraft.
